(19) United States
(12) Patent Application Publication
(10) Pub. No.: US 2022/0007384 A1
(43) Pub. Date: Jan. 6, 2022

(54) CSI-RS TRIGGERING OFFSET DETERMINATION FOR UE

(71) Applicant: QUALCOMM Incorporated, San Diego, CA (US)

(72) Inventors: Huilin Xu, Temecula, CA (US); Wooseok Nam, San Diego, CA (US); Peter Pui Lok Ang, San Diego, CA (US)

(21) Appl. No.: 17/362,410

(22) Filed: Jun. 29, 2021

Related U.S. Application Data
(60) Provisional application No. 63/047,136, filed on Jul. 1, 2020.

(51) Int. Cl. H04W 72/12; H04W 72/04; H04L 27/26

(52) U.S. Cl. CPC H04W 72/1226; H04L 27/26025; H04W 72/0446; H04W 72/1263

(57) ABSTRACT

In one aspect, an apparatus configured for wireless communication includes at least one processor; and a memory coupled to the at least one processor. The at least one processor is configured to receive a control message indicating a reference signal offset information element (IE) for aperiodic reference signal offset determination and to receive a control channel transmission indicating a particular aperiodic reference signal transmission. The at least one processor is further configured to receive the particular aperiodic reference signal transmission based on a particular reference signal offset. The particular reference signal offset is determined based on the control channel transmission and a set of reference signal offset values, which are determined based on the reference signal offset IE and on one or more minimum scheduling conditions for cross-slot scheduling. Other aspects and features are also claimed and described.

### CROSS-REFERENCE TO RELATED APPLICATIONS

This application claims the benefit of U.S. Provisional Patent Application No. 63/047,136, entitled, “CSI-RS TRIGGERING OFFSET DETERMINATION FOR UE,” filed on Jul. 1, 2020, which is expressly incorporated by reference herein in its entirety.

### TECHNICAL FIELD

Aspects of the present disclosure relate generally to wireless communication systems, and more particularly, to reference signal triggering. Certain embodiments of the technology discussed below can enable and provide enhanced interoperability between user equipment and networks.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks, which are usually multiple access networks, support communications for multiple users by sharing the available network resources.

A wireless communication network may include a number of base stations or node Bs that can support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on the downlink to a UE and/or may receive data and control information on the uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### SUMMARY

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, an apparatus configured for wireless communication includes at least one processor; and a memory coupled to the at least one processor. The at least one processor is configured to receive a control message indicating a reference signal offset information element (IE) for aperiodic reference signal offset determination and to receive a control channel transmission indicating a particular aperiodic reference signal transmission. The at least one processor is further configured to receive the particular aperiodic reference signal transmission based on a particular reference signal offset. The particular reference signal offset is determined based on the control channel transmission and a set of reference signal offset values, which are determined based on the reference signal offset IE and on one or more minimum scheduling conditions for cross-slot scheduling.

In another aspect, a method of wireless communication includes: receiving, by a user equipment (UE), a radio resource control (RRC) message indicating a Channel State Information (CSI) Reference Signal (CSI-RS) offset information element (IE) for aperiodic CSI-RS offset determination; determining, by the UE, a set of CSI-RS offset values to use based on the CSI-RS offset IE and based on one or more minimum scheduling conditions for cross-slot scheduling; receiving, by the UE, a Physical Downlink Control Channel (PDCCH) transmission indicating a particular aperiodic CSI-RS transmission; determining, by the UE, a particular CSI-RS offset for the particular aperiodic CSI-RS transmission based on the PDCCH transmission and the set of CSI-RS offset values; and receiving, by the UE, the particular aperiodic CSI-RS transmission based on the determined particular CSI-RS offset.

In an additional aspect of the disclosure, an apparatus configured for wireless communication is disclosed. The apparatus includes means for receiving, by a user equipment (UE), a radio resource control (RRC) message indicating a Channel State Information (CSI) Reference Signal (CSI-RS) offset information element (IE) for aperiodic CSI-RS offset determination; means for determining, by the UE, a set of CSI-RS offset values to use based on the CSI-RS offset IE and based on one or more minimum scheduling conditions for cross-slot scheduling; means for receiving, by the UE, a Physical Downlink Control Channel (PDCCH) transmission indicating a particular aperiodic CSI-RS transmission; means for determining, by the UE, a particular CSI-RS offset for the particular aperiodic CSI-RS transmission based on the PDCCH transmission and the set of CSI-RS offset values; and means for receiving, by the UE, the particular aperiodic CSI-RS transmission based on the determined particular CSI-RS offset.

In an additional aspect of the disclosure, a non-transitory computer-readable medium having program code recorded thereon. The program code further includes code to receive, by a user equipment (UE), a radio resource control (RRC) message indicating a Channel State Information (CSI) Reference Signal (CSI-RS) offset information element (IE) for aperiodic CSI-RS offset determination; determine, by the UE, a set of CSI-RS offset values to use based on the CSI-RS offset IE and based on one or more minimum scheduling conditions for cross-slot scheduling; receive, by the UE, a Physical Downlink Control Channel (PDCCH) transmission indicating a particular aperiodic CSI-RS transmission; determine, by the UE, a particular CSI-RS offset for the particular aperiodic CSI-RS transmission based on the PDCCH transmission and the set of CSI-RS offset values; and receive, by the UE, the particular aperiodic CSI-RS transmission based on the determined particular CSI-RS offset.

In an additional aspect of the disclosure, an apparatus configured for wireless communication is disclosed. The apparatus includes at least one processor, and a memory coupled to the processor. The processor is configured to receive, by a user equipment (UE), a radio resource control (RRC) message indicating a Channel State Information (CSI) Reference Signal (CSI-RS) offset information element (IE) for aperiodic CSI-RS offset determination; determine, by the UE, a set of CSI-RS offset values to use based on the CSI-RS offset IE and based on one or more minimum scheduling conditions for cross-slot scheduling; receive, by the UE, a Physical Downlink Control Channel (PDCCH) transmission indicating a particular aperiodic CSI-RS transmission; determine, by the UE, a particular CSI-RS offset for the particular aperiodic CSI-RS transmission based on the PDCCH transmission and the set of CSI-RS offset values; and receive, by the UE, the particular aperiodic CSI-RS transmission based on the determined particular CSI-RS offset.

In an additional aspect of the disclosure, a method of wireless communication includes:

transmitting, by a network entity, a radio resource control (RRC) message indicating a CSI-RS offset information element (IE) for aperiodic CSI-RS offset determination; determining, by the network entity, a set of Channel State Information (CSI) Reference Signal (CSI-RS) offset values to use based on the CSI-RS offset IE and based on one or more minimum scheduling conditions for cross-slot scheduling; transmitting, by the network entity, a Physical Downlink Control Channel (PDCCH) transmission indicating a particular aperiodic CSI-RS transmission; determining, by the network entity, a particular CSI-RS offset for the particular aperiodic CSI-RS based on the PDCCH transmission and the set of CSI-RS offset values; and transmitting, by the network entity, the particular aperiodic CSI-RS transmission.

In another aspect of the disclosure, an apparatus configured for wireless communication is disclosed. The apparatus includes means for transmitting, by a network entity, a radio resource control (RRC) message indicating a CSI-RS offset information element (IE) for aperiodic CSI-RS offset determination; means for determining, by the network entity, a set of Channel State Information (CSI) Reference Signal (CSI-RS) offset values to use based on the CSI-RS offset IE and based on one or more minimum scheduling conditions for cross-slot scheduling; means for transmitting, by the network entity, a Physical Downlink Control Channel (PDCCH) transmission indicating a particular aperiodic CSI-RS transmission; means for determining, by the network entity, a particular CSI-RS offset for the particular aperiodic CSI-RS based on the PDCCH transmission and the set of CSI-RS offset values; and means for transmitting, by the network entity, the particular aperiodic CSI-RS transmission.

In an additional aspect of the disclosure, a non-transitory computer-readable medium having program code recorded thereon. The program code further includes code to transmit, by a network entity, a radio resource control (RRC) message indicating a CSI-RS offset information element (IE) for aperiodic CSI-RS offset determination; determine, by the network entity, a set of Channel State Information (CSI) Reference Signal (CSI-RS) offset values to use based on the CSI-RS offset IE and based on one or more minimum scheduling conditions for cross-slot scheduling; transmit, by the network entity, a Physical Downlink Control Channel (PDCCH) transmission indicating a particular aperiodic CSI-RS transmission; determine, by the network entity, a particular CSI-RS offset for the particular aperiodic CSI-RS based on the PDCCH transmission and the set of CSI-RS offset values; and transmit, by the network entity, the particular aperiodic CSI-RS transmission.

In an additional aspect of the disclosure, an apparatus configured for wireless communication is disclosed. The apparatus includes at least one processor, and a memory coupled to the processor. The processor is configured to transmit, by a network entity, a radio resource control (RRC) message indicating a CSI-RS offset information element (IE) for aperiodic CSI-RS offset determination; determine, by the network entity, a set of Channel State Information (CSI) Reference Signal (CSI-RS) offset values to use based on the CSI-RS offset IE and based on one or more minimum scheduling conditions for cross-slot scheduling; transmit, by the network entity, a Physical Downlink Control Channel (PDCCH) transmission indicating a particular aperiodic CSI-RS transmission; determine, by the network entity, a particular CSI-RS offset for the particular aperiodic CSI-RS based on the PDCCH transmission and the set of CSI-RS offset values; and transmit, by the network entity, the particular aperiodic CSI-RS transmission.

Other aspects, features, and embodiments will become apparent to those of ordinary skill in the art, upon reviewing the following description of specific, exemplary embodiments in conjunction with the accompanying figures. While features may be discussed relative to certain aspects and figures below, all embodiments can include one or more of the advantageous features discussed herein. In other words, while one or more aspects may be discussed as having certain advantageous features, one or more of such features may also be used in accordance with the various aspects. In similar fashion, while exemplary aspects may be discussed below as device, system, or method aspects, the exemplary aspects can be implemented in various devices, systems, and methods.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of a wireless communication system according to some embodiments of the present disclosure.

FIG. 2 is a block diagram conceptually illustrating a design of a base station and a UE configured according to some embodiments of the present disclosure.

FIG. 3A is a timing ladder diagram of an example of periodic CSI-RS triggering.

FIG. 3B is a timing ladder diagram of an example of aperiodic CSI-RS triggering.

FIG. 4 is a block diagram illustrating an example of a wireless communications system (with a UE and base station) with conditional extended CSI-RS offset operation.

FIG. 5 is a ladder diagram of a first example of conditional extended CSI-RS offset operations according to some embodiments of the present disclosure.

FIG. 6 is a ladder diagram of a second example of conditional extended CSI-RS offset operations according to some embodiments of the present disclosure.

FIG. 7 is a flow diagram illustrating example blocks executed by a UE configured according to an aspect of the present disclosure.

FIG. 8 is a flow diagram illustrating example blocks executed by a base station configured according to an aspect of the present disclosure.

FIG. 9 is a flow diagram illustrating another example blocks executed by a UE configured according to an aspect of the present disclosure.

FIG. 10 is a flow diagram illustrating another example blocks executed by a base station configured according to an aspect of the present disclosure.

FIG. 11 is a block diagram conceptually illustrating a design of a UE configured to perform precoding information update operations according to some embodiments of the present disclosure.

FIG. 12 is a block diagram conceptually illustrating a design of a base station configured to perform precoding information update operations according to some embodiments of the present disclosure.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure is related to aperiodic reference signal (e.g., CSI-RS) triggering schemes and operations for wireless communications. Conventionally, CSI-RS transmissions are scheduled, such as signaled or triggered, periodically or aperiodically. To illustrate, a network may schedule multiple CSI-RS transmissions occurring in set intervals or may trigger a single CSI-RS transmission with a particular offset from a scheduling transmission. The offset may be indicated by an offset indicator and decoded by a user device using a set of potential offsets. The set of potential offsets (e.g., list of offset values) may be included in an information element received from the network. However, some lists of offset values or some offset values of certain lists may be incompatible with some user equipment, some operating modes, previous generation devices, new generation networks, or result in worse performance. Thus, interoperability (e.g., backwards compatibility) and/or performance can be increased by conditionally using such problematic lists of offset values.

One such example of problem is for cross-slot scheduling. For example, one or more minimum scheduling conditions (e.g., restrictions) for cross-slot scheduling which are configured to reduce power. Some cross-slot scheduling conditions for power savings specify a minimum offset between operations. When a Release 15 UE without such minimum offset conditions receives a Release 16 set of offset values, the Release 15 UE may not be able to operate in the network.

In the present disclosure, sets of offset values may be evaluated for use/conditionally used to prevent or reduce interoperability issues and/or performance reductions. Thus, a UE or network may determine to conditionally use offset values based on current configurations. Such techniques can improve interoperability and increase power savings.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks/systems/devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The Third Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with Universal Terrestrial Radio Access Networks (UTRANs) in the case of a UMTS/GSM network. Additionally, an operator network may also include one or more LTE networks, and/or one or more other networks. The various different network types may use different radio access technologies (RATs) and radio access networks (RANs).

An OFDMA network may implement a radio technology such as evolved UTRA (E-UTRA), IEEE 802.11, IEEE 802.16, IEEE 802.20, flash-OFDM and the like. UTRA, E-UTRA, and Global System for Mobile Communications (GSM) are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP long term evolution (LTE) is a 3GPP project which was aimed at improving the universal mobile telecommunications system (UMTS) mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects descried with reference to one technology may be understood to be applicable to another technology. Indeed, one or more aspects of the present disclosure are related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD)/frequency division duplex (FDD) design; and advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and/or other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or OEM devices or systems incorporating one or more described aspects. In some practical settings, devices incorporating described aspects and features may also necessarily include additional components and features for implementation and practice of claimed and described embodiments. It is intended that innovations described herein may be practiced in a wide variety of implementations, including both large/small devices, chip-level components, multi-component systems (e.g. RF-chain, communication interface, processor), distributed arrangements, end-user devices, etc. of varying sizes, shapes, and constitution.

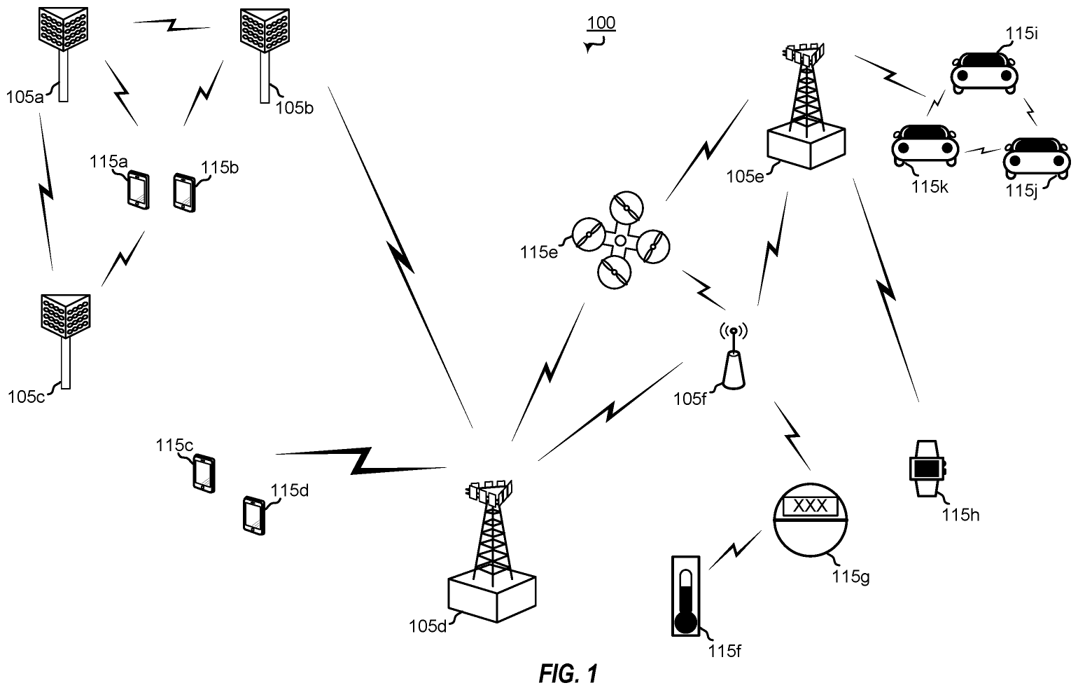

FIG. 1 is a block diagram illustrating details of an example wireless communication system. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” can refer to this particular geographic coverage area of a base station and/or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as user equipment (UE) in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component device/module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an “Internet of things” (IoT) or “Internet of everything” (IoE) device such as an automotive or other transportation vehicle, a satellite radio, a global positioning system (GPS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink and/or uplink, or desired transmission between base stations, and backhaul transmissions between base stations. UEs may operate as base stations or other network nodes in some scenarios. Backhaul communication between base stations of wireless network 100 may occur using wired and/or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD/FDD communications, such as in a vehicle-to-vehicle (V2V) mesh network between UEs 115i-115k communicating with macro base station 105e.

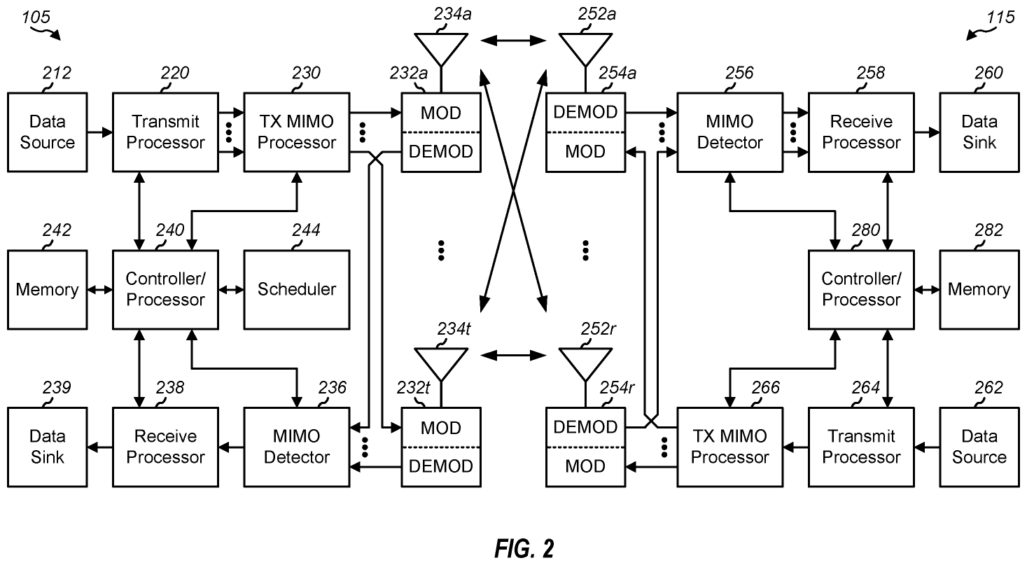

FIG. 2 shows a block diagram conceptually illustrating an example design of a base station 105 and a UE 115, which may be any of the base stations and one of the UEs in FIG. 1. For a restricted association scenario (as mentioned above), base station 105 may be small cell base station 105f in FIG. 1, and UE 115 may be UE 115c or 115D operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller/processor 240. The control information may be for the physical broadcast channel (PBCH), physical control format indicator channel (PCFICH), physical hybrid-ARQ (automatic repeat request) indicator channel (PHICH), physical downlink control channel (PDCCH), enhanced physical downlink control channel (EPDCCH), MTC physical downlink control channel (MPDCCH), etc. The data may be for the PDSCH, etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) multiple-input multiple-output (MIMO) processor 230 may perform spatial processing (e.g., precoding) on the data symbols, the control symbols, and/or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, the antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller/processor 280.

On the uplink, at UE 115, transmit processor 264 may receive and process data (e.g., for the physical uplink shared channel (PUSCH)) from data source 262 and control information (e.g., for the physical uplink control channel (PUCCH)) from controller/processor 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Processor 238 may provide the decoded data to data sink 239 and the decoded control information to controller/processor 240.

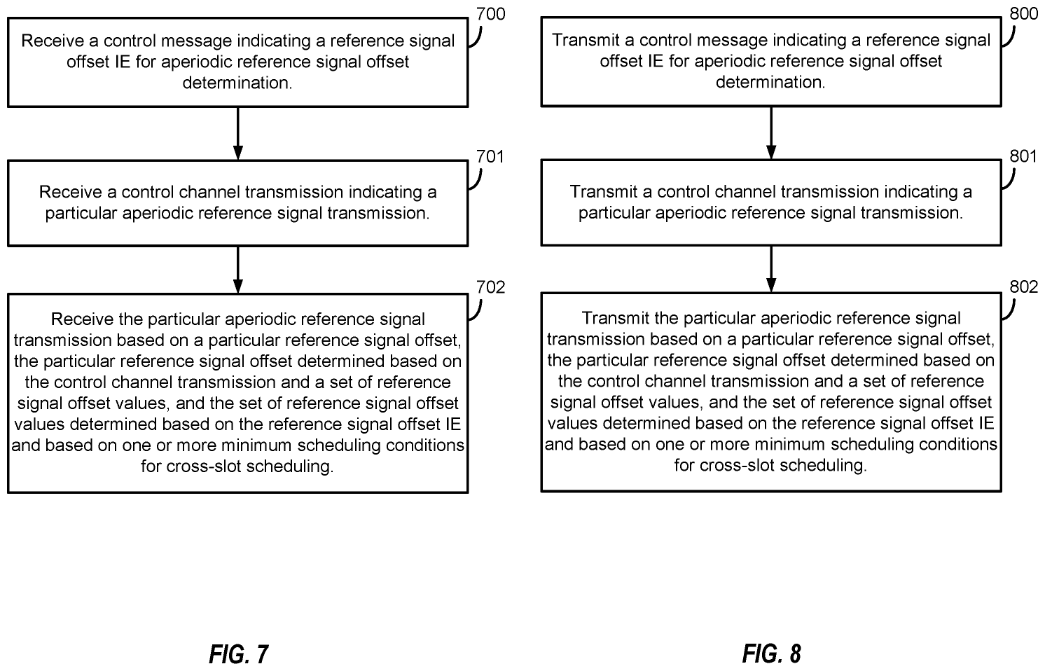

Controllers/processors 240 and 280 may direct the operation at base station 105 and UE 115, respectively. Controller/processor 240 and/or other processors and modules at base station 105 and/or controller/processor 280 and/or other processors and modules at UE 115 may perform or direct the execution of various processes for the techniques described herein, such as to perform or direct the execution illustrated in FIGS. 7-10 and/or other processes for the techniques described herein. Memories 242 and 282 may store data and program codes for base station 105 and UE 115, respectively. Scheduler 244 may schedule UEs for data transmission on the downlink and/or uplink.

Wireless communications systems operated by different network operating entities (e.g., network operators) may share spectrum. In some instances, a network operating entity may be configured to use an entirety of a designated shared spectrum for at least a period of time before another network operating entity uses the entirety of the designated shared spectrum for a different period of time. Thus, in order to allow network operating entities use of the full designated shared spectrum, and in order to mitigate interfering communications between the different network operating entities, certain resources (e.g., time) may be partitioned and allocated to the different network operating entities for certain types of communication.

For example, a network operating entity may be allocated certain time resources reserved for exclusive communication by the network operating entity using the entirety of the shared spectrum. The network operating entity may also be allocated other time resources where the entity is given priority over other network operating entities to communicate using the shared spectrum. These time resources, prioritized for use by the network operating entity, may be utilized by other network operating entities on an opportunistic basis if the prioritized network operating entity does not utilize the resources. Additional time resources may be allocated for any network operator to use on an opportunistic basis.

Access to the shared spectrum and the arbitration of time resources among different network operating entities may be centrally controlled by a separate entity, autonomously determined by a predefined arbitration scheme, or dynamically determined based on interactions between wireless nodes of the network operators.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel and/or the acknowledge/negative-acknowledge (ACK/NACK) feedback for its own transmitted packets as a proxy for collisions.

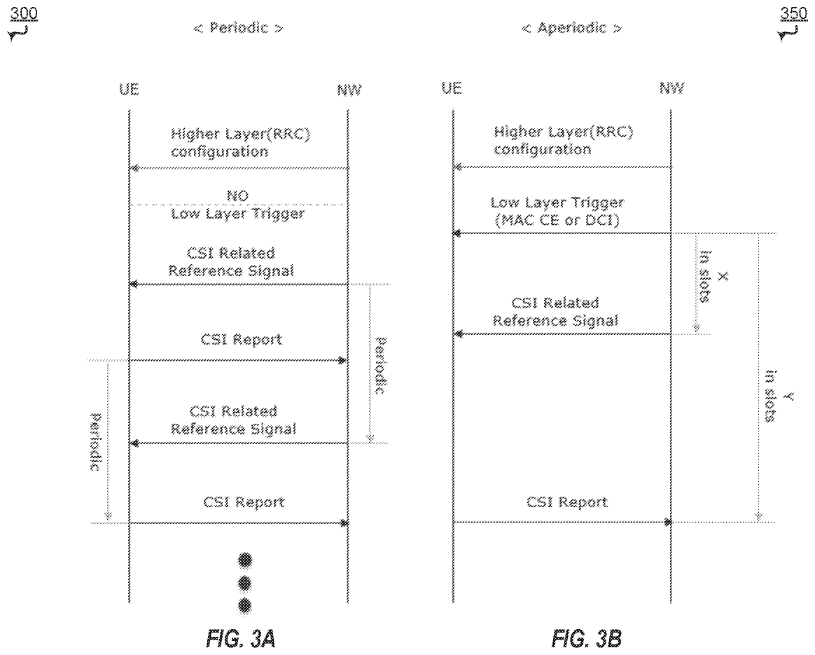

FIGS. 3A and 3B illustrate examples of CSI-RS operations for different CSI-RS scheduling schemes. In FIG. 3A periodic scheduling operations are shown, and in FIG. 3B aperiodic scheduling operations are shown.

Periodic scheduling operations correspond to scheduling multiple transmissions with a single setup, often by a single message. Aperiodic scheduling operations correspond to scheduling (e.g., triggering) a single item with a single transmission/message. A third option, semi-persistent scheduling, can be regarded as a kind of mix of Periodic and Aperiodic scheduling. The first cycle in semi-persistent scheduling would be similar to Aperiodic scheduling, but once the first cycle is triggered by a single transmission/message, CSI-RS transmissions and CSI Reports would happen periodically.

Referring to FIG. 3A, the diagram 300 illustrates two devices, a UE and a network device (NW) and illustrates communications between the two devices. FIG. 3A further illustrates a timing between transmissions exchanged by the two devices. In the example illustrated in FIG. 3A, the network (NW) transmits a higher layer configuration message, such as an RRC message. The RRC message configures and schedules multiple CSI-RS transmissions with a particular periodicity, as illustrated in FIG. 3A.

The periodicity shown in FIG. 3A is configured by the RRC message. Depending on the physical channel and report periodicity type, a different RRC parameter may be used for indicating the periodicity. For example, a reportSlotConfig IE or a reportSlotOffsetList IE may be used to indicate the periodicity. The reportSlotConfig IE may be used for CSI reporting in PUCCH, and the reportSlotOffsetList IE may be used for CSI reporting in PUSCH.

The network transmits the multiple CSI-RS transmissions to the UE according to the periodicity and without a lower layer, such as MAC or physical layer, triggering transmission. After receiving the CSI-RS transmissions, the UE generates a CSI report and transmits the CSI report to the network according to the periodicity. These operations may continue until the network reconfigures the CSI-RS scheduling scheme, such as by transmitting another higher layer message or transmitting a lower layer message.

Referring to FIG. 3B, the diagram 350 illustrates two devices, a UE and a network device (NW) and illustrates communications between the two devices. FIG. 3B further illustrates timings between transmissions exchanged by the two devices. In the example illustrated in FIG. 3B, the network (NW) transmits a higher layer configuration message, such as an RRC message, to the UE. The RRC message configures CSI-RS transmissions for aperiodic triggering, as illustrated in FIG. 3B. For example, the RRC message includes an aperiodicTriggeringOffset IE, which includes a standard set of CSI-RS offset values for which the UE should or must use. To illustrate, the UE may have to universally use such an IE for particular operating modes and may not conditionally use the IE based on UE capabilities, UE configurations, or UE conditions.

After configuration, the network may occasionally, transmit a lower layer message (e.g., trigger message) which schedules/triggers individual CSI-RS transmissions, and optionally, the corresponding CSI report. In the example of FIG. 3B, the network device transmits a DCI, a MAC CE, or both, to trigger a CSI-RS transmission and a corresponding CSI report. Such triggering transmissions may be sent in/via a PDCCH transmission.

The triggering offsets shown in FIG. 3B is X slots for the CSI-RS transmission and Y slots for the corresponding CSI report as measured from the lower layer message (e.g., trigger message). The aperiodic CSI-RS timing offset X refers to the time gap between aperiodic CSI-RS triggering and the aperiodic CSI-RS transmission with regard to the number of slots. The aperiodic CSI reporting timing offset Y refers to the time gap between aperiodic CSI reporting triggering and aperiodic CSI reporting with regard to the number of slots. The aperiodic CSI-RS timing offsets X and Y in this illustration may be defined as in TS 38.331.

The UE determines the aperiodic CSI-RS timing offset X based on the aperiodicTriggeringOffset IE. To illustrate, the UE determines an indicator from the lower layer message and uses the indicator to identify an entry of the aperiodicTriggeringOffset IE. A value of the entry of the aperiodicTriggeringOffset IE corresponds to the value for X. The UE then monitors the particular slot for the CSI-RS transmission from the network device.

After receiving the CSI-RS transmission, the UE generates a CSI report and transmits the CSI report to the network. The aperiodic CSI-RS timing offset Y may be determined similar to the aperiodic CSI-RS timing offset X. The UE may use the aperiodicTriggeringOffset IE to determine offset values until the network reconfigures the CSI-RS offset values, such as by transmitting another higher layer message or transmitting a lower layer message.

The present disclosure describes enhanced CSI-RS aperiodic triggering, such as conditional usage of extended sets of CSI-RS offset value or usage of fixed offsets. Such enhanced CSI-RS aperiodic triggering can alleviate interoperability issues (e.g., backward compatibility issues) that may arise and can improve performance in some operating modes and/or under certain conditions. Thus, a UE configured with enhanced CSI-RS aperiodic triggering may have increased flexibility and performance as compared to conventional UEs which use receive sets of offset values universally/globally.

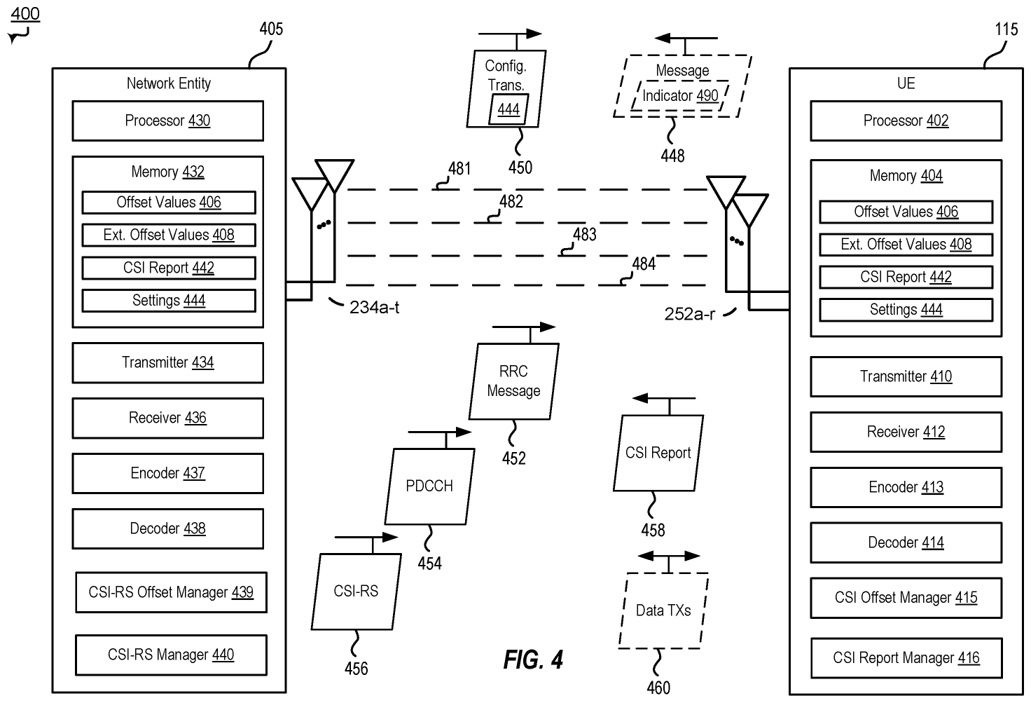

FIG. 4 illustrates an example of a wireless communications system 400 that supports enhanced CSI-RS aperiodic triggering changing in accordance with aspects of the present disclosure. In some examples, wireless communications system 400 may implement aspects of wireless communication system 100. For example, wireless communications system 400 may include UE 115 and network entity 405. Enhanced CSI-RS aperiodic triggering operations may increase UE interoperability and may reduce power consumption by enabling the conditional usage of CSI-RS offset values based on cross-slot scheduling settings (e.g., cross-slot scheduling settings for power saving). Thus, network and device performance can be increased.

Network entity 405 and UE 115 may be configured to communicate via frequency bands, such as FR1 having a frequency of 410 to 7125 MHz, FR2 having a frequency of 24250 to 52600 MHz for mm-Wave, and/or one or more other frequency bands. It is noted that sub-carrier spacing (SCS) may be equal to 15, 30, 60, or 120 kHz for some data channels. Network entity 405 and UE 115 may be configured to communicate via one or more component carriers (CCs), such as representative first CC 481, second CC 482, third CC 483, and fourth CC 484. Although four CCs are shown, this is for illustration only, more or fewer than four CCs may be used. One or more CCs may be used to communicate control channel transmissions, data channel transmissions, and/or sidelink channel transmissions.

Such transmissions may include a Physical Downlink Control Channel (PDCCH), a Physical Downlink Shared Channel (PDSCH), a Physical Uplink Control Channel (PUCCH), a Physical Uplink Shared Channel (PUSCH), a Physical Sidelink Control Channel (PSCCH), a Physical Sidelink Shared Channel (PSSCH), or a Physical Sidelink Feedback Channel (PSFCH). Such transmissions may be scheduled by aperiodic grants and/or periodic grants.

Each periodic grant may have a corresponding configuration, such as configuration parameters/settings. The periodic grant configuration may include configured grant (CG) configurations and settings. Additionally, or alternatively, one or more periodic grants (e.g., CGs thereof) may have or be assigned to a CC ID, such as intended CC ID.

Each CC may have a corresponding configuration, such as configuration parameters/settings. The configuration may include bandwidth, bandwidth part, HARQ process, TCI state, RS, control channel resources, data channel resources, or a combination thereof. Additionally, or alternatively, one or more CCs may have or be assigned to a Cell ID, a Bandwidth Part (BWP) ID, or both. The Cell ID may include a unique cell ID for the CC, a virtual Cell ID, or a particular Cell ID of a particular CC of the plurality of CCs. Additionally, or alternatively, one or more CCs may have or be assigned to a HARQ ID. Each CC may also have corresponding management functionalities, such as, beam management, BWP switching functionality, or both. In some implementations, two or more CCs are quasi co-located, such that the CCs have the same beam and/or same symbol.

In some implementations, control information may be communicated via network entity 405 and UE 115. For example, the control information may be communicated suing MAC-CE transmissions, RRC transmissions, DCI, transmissions, another transmission, or a combination thereof.

UE 115 can include a variety of components (e.g., structural, hardware components) used for carrying out one or more functions described herein. For example, these components can include processor 402, memory 404, transmitter 410, receiver 412, encoder, 413, decoder 414, CSI-RS offset manager 415, CSI report manager 416 and antennas 252a-r. Processor 402 may be configured to execute instructions stored at memory 404 to perform the operations described herein. In some implementations, processor 402 includes or corresponds to controller/processor 280, and memory 404 includes or corresponds to memory 282. Memory 404 may also be configured to store offset values data 406, extended offset values data 408, CSI report data 442, settings data 444, or a combination thereof, as further described herein.

The offset values data 406 includes or corresponds to data associated with or corresponding to a standard set of CSI-RS offset values. For example, the offset values data 406 may indicate a particular set of CSI-RS offset values to use for certain operating modes/conditions. The offset values data 406 may include a standard set of offset values, such as 7 offset values. For example, the offset values may include {0, 1, 2, 3, 4, 16, 24}.

The extended offset values data 408 includes or corresponds to data associated with or corresponding to an extended set of CSI-RS offset values. For example, the extended offset values data 406 may indicate a particular extended set of CSI-RS offset values to use for certain operating modes/conditions.

The extended offset values data 408 may include an extended set of offset values, such as more than 7 offset values. For example, the offset values may include 18 values or 32 values. To illustrate, the offset values may include {0, 1, 2, 3, 4, 5, 6, . . . , 15, 16, 24} or {0, 1, 2, 3, 4, 5, 6, . . . , 29, 30, 31}. In a particular implementation, the extended set of values is indicated by or included in a new IE, such as an aperiodicTriggeringOffsetExt-r16 IE, as compared to the aperiodicTriggeringOffset IE.

The CSI report data 442 includes or corresponds to data associated with or corresponding to a CSI report. The CSI report data 442 may include or be used to indicate one or more of CQI (Channel Quality Information), PMI (Precoding Matrix Indicator), CRI (CSI-RS Resource Indicator), SSBRI (SS/PBCH Resource Block Indicator), LI (Layer Indicator), RI (Rank Indicator) an/or L1-RSRP. The settings data 444 includes or corresponds to data associated with enhanced CSI-RS offset operations. The settings data 444 may include one or more types of CSI-RS offset operations modes and/or thresholds or conditions for switching CSI-RS offset modes and/or between sets of CSI-RS offset values.

Transmitter 410 is configured to transmit data to one or more other devices, and receiver 412 is configured to receive data from one or more other devices. For example, transmitter 410 may transmit data, and receiver 412 may receive data, via a network, such as a wired network, a wireless network, or a combination thereof. For example, UE 115 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 410 and receiver 412 may be replaced with a transceiver. Additionally, or alternatively, transmitter 410, receiver, 412, or both may include or correspond to one or more components of UE 115 described with reference to FIG. 2.

Encoder 413 and decoder 414 may be configured to encode and decode data for transmission. CSI-RS offset manager 415 may be configured to determine and perform aperiodic CSI-RS operations. For example, CSI-RS offset manager 415 is configured to determine a particular set of CSI-RS offset values to use and determine CSI-RS offset timings based on trigger signals (e.g., which particular offset value to use from the set of CSI-RS offset values). CSI report manager 416 may be configured to determine to a particular CSI report configuration, timing, or both. For example, CSI report manager 416 is configured to determine and/or select a particular CSI report offset.

Network entity 405 includes processor 430, memory 432, transmitter 434, receiver 436, encoder 437, decoder 438, CSI-RS offset manager 439, CSI-RS manager 440, and antennas 234a-t. Processor 430 may be configured to execute instructions stores at memory 432 to perform the operations described herein. In some implementations, processor 430 includes or corresponds to controller/processor 240, and memory 432 includes or corresponds to memory 242. Memory 432 may be configured to store offset values data 406, extended offset values data 408, CSI report data 442, settings data 444, or a combination thereof, similar to the UE 115 and as further described herein.

Transmitter 434 is configured to transmit data to one or more other devices, and receiver 436 is configured to receive data from one or more other devices. For example, transmitter 434 may transmit data, and receiver 436 may receive data, via a network, such as a wired network, a wireless network, or a combination thereof. For example, network entity 405 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 434 and receiver 436 may be replaced with a transceiver. Additionally, or alternatively, transmitter 434, receiver, 436, or both may include or correspond to one or more components of network entity 405 described with reference to FIG. 2.

Encoder 437, and decoder 438 may include the same functionality as described with reference to encoder 413 and decoder 414, respectively. CSI-RS offset manager 439 may include similar functionality as described with reference to CSI-RS offset manager 415. CSI-RS manager 440 may be configured to determine to a particular CSI-RS configuration, timing, or both. For example, CSI-RS manager 416 is configured to determine and/or select a set of CSI-RS signals to transmit and optionally when to transmit them.

During operation of wireless communications system 400, network entity 405 may determine that UE 115 has enhanced CSI-RS offset operations capability. For example, UE 115 may transmit a message 448 that includes an enhanced CSI-RS offset indicator 490. Indicator 490 may indicate enhanced CSI-RS offset operation capability or a particular type or mode of enhanced CSI-RS offset operation. In some implementations, network entity 405 sends control information to indicate to UE 115 that enhanced CSI-RS offset operation and/or a particular type of enhanced CSI-RS offset operation is to be used. For example, in some implementations, message 448 (or another message, such as configuration transmission 450) is transmitted by the network entity 405. The configuration transmission 450 may include or indicate to use enhanced CSI-RS offset operation or to adjust or implement a setting of a particular type of enhanced CSI-RS offset operation.

During operation, devices of wireless communications system 400, perform enhanced

CSI-RS offset operations. For example, a network entity 405 may transmit an RRC message 452 to the UE 115. The RRC message 452 may be a CSI-RS configuration message and include CSI-RS offset value data, such as 406, 408, or both. For example, the RRC message 452 may include or indicate a particular information element (IE) of offset values, such as an IE which includes a standard set of offset values or an extended set of offset values. To illustrate, the RRC message 452 may indicate an aperiodicTriggeringOffset IE or an aperiodicTriggeringOffsetExt-r16 IE. The aperiodicTriggeringOffset IE may correspond to a standard set of offset values in some implementations. The aperiodicTriggeringOffsetExt-r16 IE may correspond to a particular extended set or a super extended set which is larger than the extended set of the aperiodicTriggeringOffset IE. The aperiodicTriggeringOffsetExt-r16 IE may be associated with different evaluation conditions and/or modes than the aperiodicTriggeringOffset IE.

As another illustration, the RRC message 452 may include or indicate a fixed CSI-RS offset value for aperiodic or triggered CSI-RS transmissions, such as zero. The fixed CSI-RS offset value may be indicated by the aperiodicTriggeringOffset IE (i.e., a set of 1 offset value), by another indicator in the RRC message 452, or by indication in a triggering message, such as PDCCH transmission 454. Alternatively, the network entity 405 may transmit a different higher layer message in place of the RRC message 452 to configure CSI-RS timing offsets.

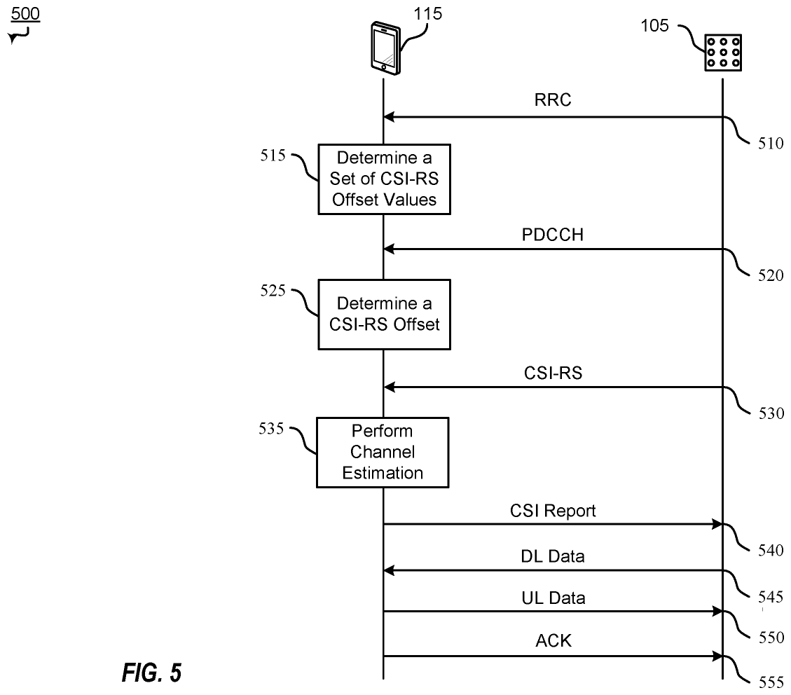

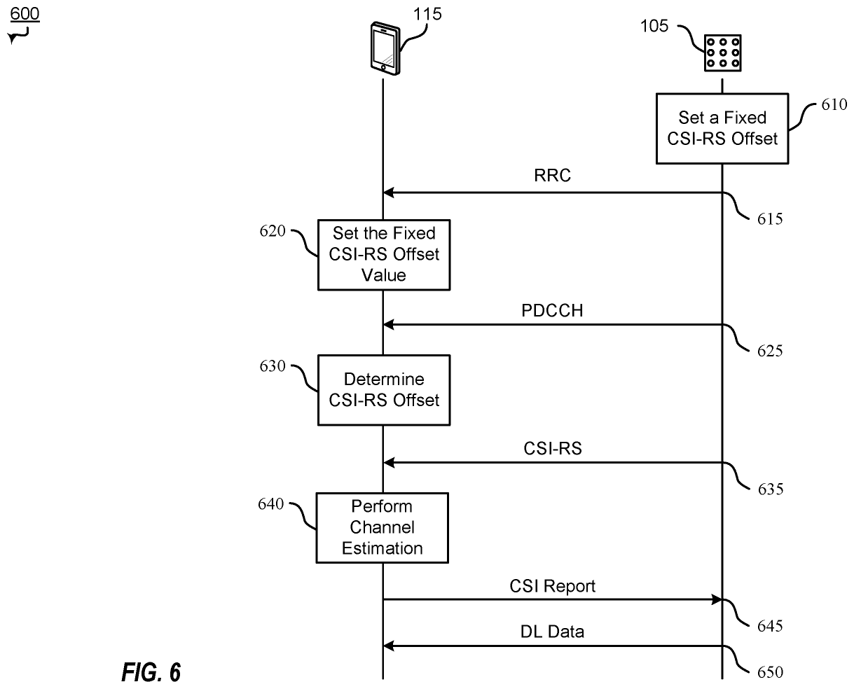

After receiving the RRC message 452, the UE 115 may determine a particular set of CSI-RS offset values to use based on the RRC message 452 and one or more minimum scheduling conditions for cross-slot scheduling. For example, the UE 115 may determine whether to use the set of offset values included in or indicated by RRC message 452 based on one or more minimum scheduling restrictions for the support of cross-slot scheduling for power saving in DL, UL, or both, such as minimumSchedulingOffsetK0 IE, minimumSchedulingOffsetK2 IE, or both. To illustrate, the UE 115 determines whether it is configured with a minimum SchedulingOffsetK0 IE for any DL BWP and/or whether it is configured with a minimumSchedulingOffsetK2 IE for any UL BWP. Based on such determinations indicating that the UE 115 is configured with at least some form of cross-slot scheduling and/or power saving, the UE 115 may determine to use the extended set of offset values (e.g., aperiodicTriggeringOffset IE) included in or indicated by RRC message 452. Additional details on such determinations are described further with reference to FIGS. 5 and 6. Thus, the UE 115 may determine to conditionally use the received set of CSI-RS offset values instead of universally or globally use such values. Accordingly, the UE 115 may have increased flexibility and performance by conditionally (e.g., only) using such received (e.g., extended set of) CSI-RS offset values when it benefits the UE and/or when it does not cause conflicts with other settings, such as cross-slot scheduling settings.

The network entity 405 may transmit a PDCCH transmission 454 to the UE 115 to indicate (e.g., trigger, schedule, or signal) a particular CSI-RS transmission, such as a CSI-RS transmission 456. The PDCCH transmission 454 may be a downlink control message, such as a DCI transmission, or a MAC CE. For example, the PDCCH transmission 454 may include or correspond to a DCI transmission or a MAC CE which triggers the CSI-RS transmission 456. In a particular implementation a combination of DCI and MAC CE triggers the CSI-RS transmission 456.

The PDCCH transmission 454 may include an indicator which points to or identifies a particular value in the selected set of CSI-RS offset values determined by the UE. For example, the indicator may include or correspond to multiple bits which point to a particular entry/location of the selected set of CSI-RS offset values determined by the UE. A value of the indicated entry/location of the selected set of CSI-RS offset values determined by the UE corresponds to the indicated offset value for the triggered CSI-RS transmission. As an illustrative example, the indicator may indicate a fourth entry, which has a value of 3 and then the offset is determined to be 3 slots between the PDCCH transmission 454 and the CSI-RS transmission 456. In other implementations, the value identified by the indicator corresponds to the number slots between the PDCCH transmission 454 and the CSI-RS transmission 456. For example, a formula or table may be used to convert the identified value to a slot number. To illustrate, a value of 0 may indicate/correspond to a next slot, instead of a current slot.

The UE 115 determines the particular CSI-RS offset for the CSI-RS transmission 456 based on the PDCCH transmission 452 and the selected set of CSI-RS offset values. For example, the UE 115 may parse the PDCCH transmission 452 to identify or extract an indicator or indicators. The UE 115 may decode the indicator to determine an entry of the selected set of CSI-RS offset values. The UE 115 may determine the CSI-RS offset based on the entry, such as directly or indirectly. To illustrate, the UE 115 may directly use the value indicated as a number of slots between the PDCCH transmission 454 and the CSI-RS transmission 456, or may indirectly use the value indicated to determine the number of slots by using the indicated value in a formula or lookup table to determine the number of slots between the PDCCH transmission 454 and the CSI-RS transmission 456. The UE 115 then monitors for the CSI-RS transmission 456 at the determined time.

Similarly, the network entity 405 determines the offset for the CSI-RS transmission 456. The network entity 405 generates and transmits the CSI-RS transmission 456 at the determined time. The UE 115 receives the CSI-RS transmission 456 transmitted by the network entity 405.

The UE 115 may generate a CSI report 458 based on the CSI-RS transmission 456, as described further with reference to FIGS. 5 and 6. The UE 115 may determine a CSI report offset for the CSI report 458 similar to how the UE 115 determines the CSI-RS offset. To illustrate, the UE 115 may use the indicator for the CSI-RS offset or determine a second indicator from the PDCCH transmission 454 and use the indicator or second indicator to determine a CSI report offset. In some implementations, the UE 115 uses the second indicator to identify an entry of a set of CSI report offset values determined by the UE 115. To illustrate, the UE 115 receives a set of CSI report offset values in the RRC message 452 and determines whether to use such CSI report offset values based on one or more conditions (e.g., cross-slot scheduling conditions).

Alternatively, the UE 115 may determine the CSI report offset based on conventional operations, such as based on a received set of CSI report offset values indicated by or included in the RRC message 452 and not based on any conditions, such as cross-slot scheduling conditions. The UE 115 may transmit the CSI report 458 to the network entity 405 at the determined CSI report offset.

Similarly, the network entity 405 determines the offset for the CSI report 458. The network entity 405 monitors for the CSI report 458 at the determined time and receives the CSI report 458. The network entity 405 may use the CSI report 458 to optionally exchange data with the UE 115, by sending and/or receiving data transmissions 460 according to or based on the CSI report 458.

For example, the network entity 405 and UE 115 perform data transmissions 460 based on the configurations and/or parameters indicated by the CSI report. To illustrate, the UE 115 transmits UL data to the network entity 405 with CSI report 458 indicated transmission settings and/or the network entity 405 transmits downlink data to the UE 115 with CSI report 458 indicated transmission settings.

Thus, the UE 115 may conditionally determine when to use sets of CSI-RS offset values received from a network. Therefore, the UE 115 may be able to increase interoperability in different networks (e.g., prevent backward incompatibility) and increase performance (e.g., prevent performance decrease) for some modes. Accordingly, the UE 115 and network entity 405 may be able to perform cross-slot scheduling power saving operations with extended sets of CSI-RS offset values.

Therefore, FIG. 4 describes enhanced CSI-RS triggering operations for aperiodic CSI-RS triggering. Using such CSI-RS triggering operations may enable improvement when operating in some modes, such as with cross-slot scheduling conditions and/or particular numerologies. Performing enhanced CSI-RS triggering operations enables improved throughput and reduced latency and thus, enhanced UE and network performance.

FIGS. 5 and 6 illustrate examples of ladder diagrams for enhanced CSI-RS triggering operation. Referring to FIG. 5, FIG. 5 is a ladder diagram of an example CSI-RS triggering operations where a UE evaluates whether to conditionally use a received set of CSI-RS offset values. In the example of FIG. 5, the ladder diagram illustrates a UE and a network entity, such as base station 105.

At 510, the base station 105 (e.g., gNB) generates and transmits an RRC message. For example, the base station 105 sends an RRC configuration message for CSI-RS, such as a aperiodic CSI-RS configuration message, to the UE 115. The RRC message includes or indicates a set of CSI-RS offset values for aperiodic trigger time determination. As described above, the RRC message may indicate or include an IE that includes a standard set or extended set of CSI-RS values. Alternatively, the RRC may indicate or include a fixed CSI-RS offset indicator or an IE that includes a set of 1 fixed CSI-RS offset value, as described further with reference to FIG. 6.

At 515, the UE 115 determines a set of CSI-RS offset values based on the RRC message and one or more conditions. For example, the UE 115 evaluates one or more cross-slot scheduling conditions for using the set of CSI-RS offset values included in or indicated by the RRC message, such as an extended set of CSI-RS values. The cross-slot scheduling conditions may include or correspond to Release 16 cross-slot scheduling conditions for UL, DL, or both.

Additionally, or alternatively, the UE may determine to use the received set of CSI-RS offset values based on alternative conditions and/or additional conditions. One such example of an alternative or an additional conditions is a numerology condition. For example, the UE 115 may use first cross-slot scheduling conditions to evaluate whether to use the received set of CSI-RS offset values when the PDCCH and the CSI-RS have the same numerology and may use second cross-slot scheduling conditions to evaluate whether to use the received set of CSI-RS offset values when the PDCCH and the CSI-RS have different numerologies. Numerology may include or correspond to a sub-carrier spacing (SCS), a cyclic prefix (CP) type, or both, of a transmission. The CP type may include a normal CP (NCP) type, an extend CP (ECP) type, or both. Thus, a same numerology includes or corresponds to a same SCS and/or a same CP type, and a different numerology may include or correspond to a different SCS and/or a different CP type.

As an illustrative example of a different SCS, when the PDCCH has a larger SCS than the SCS of the CSI-RS, the UE 115 may determine to evaluate using the received set of CSI-RS offset values. As another illustrative example same numerology, when the PDCCH and CSI-RS transmissions have the same SCS and CP type, the UE 115 may determine to evaluate using the received set of CSI-RS offset values. In such illustrative examples the UE 115 may determine to use the received set of globally or unconditionally when the PDCCH has a smaller SCS than the SCS of the CSI-RS (e.g., a particular case of different numerologies).

In some implementations, the UE 115 applies the received set of CSI-RS offset values conditionally and evaluates whether to use the received set of CSI-RS offset values when the numerology is the same and when the PDCCH has a larger SCS than the SCS of the CSI-RS (e.g., a particular type of different numerology). In some such implementations, the UE 115 may determine to use the received set of CSI-RS offset values based on cross-slot scheduling configuration for downlink, uplink, or both.

In a first example, the UE 115 determines whether the UE is configured with a minimumSchedulingOffsetK0 IE for any downlink BWP, and the UE 115 determines to use the received CSI-RS offset IE based on determining that the UE is configured with a minimumSchedulingOffsetK0 IE for any downlink BWP. Additionally, or alternatively, the UE 115 determines to use an alternative CSI-RS offset IE (e.g., standard set) based on determining that the UE is not configured with a minimumSchedulingOffsetK0 IE for any downlink BWP.

In a second example, the UE 115 determines whether the UE is configured with a minimumSchedulingOffsetK0 IE for any downlink BWP or a minimumSchedulingOffsetK2 IE for any uplink BWP, and the UE 115 determines to use the received CSI-RS offset IE based on determining that the UE is configured with a minimumSchedulingOffsetK0 IE for any downlink BWP or with a minimumSchedulingOffsetK2 IE for any uplink BWP. Additionally, or alternatively, the UE 115 determines to use an alternative CSI-RS offset IE based on determining that the UE is not configured with a minimumSchedulingOffsetK0 IE for any downlink BWP and not configured with a minimumSchedulingOffsetK2 IE for any uplink BWP.

In a third example, the UE 115 determines whether the UE is configured with a minimumSchedulingOffsetK0 IE for any downlink BWP and with a minimumSchedulingOffsetK2 IE for any uplink BWP, and the UE 115 determines to use the received CSI-RS offset IE based on determining that the UE is configured with a minimumSchedulingOffsetK0 IE for any downlink BWP and with a minimumSchedulingOffsetK2 IE for any uplink BWP. Additionally, or alternatively, the UE 115 determines to use an alternative CSI-RS offset IE based on determining that the UE is not configured with a minimumSchedulingOffsetK0 IE for any downlink BWP or not configured with a minimumSchedulingOffsetK2 IE for any uplink BWP.

At 520, the base station 105 (e.g., gNB) generates and transmits a PDCCH transmission. For example, the base station 105 sends a DCI or a MAC CE to trigger a particular CSI-RS transmission, i.e., an aperiodic CSI-RS transmission. The PDCCH transmission includes or indicates an indicator for the selected set of CSI-RS offset values. The indicator is configured to identify an entry of the selected set of CSI-RS offset values, and a value of the identified entry is the determined offset or further indicates the determined offset.

At 525, the UE 115 determines a particular CSI-RS offset for the aperiodic CSI-RS transmission. For example, the UE 115 determines a particular offset, such as a number of slots, between the PDCCH transmission and the CSI-RS transmission based on parsing the PDCCH transmission for an indicator and using the indicator to identify a value in the selected set of CSI-RS offset values. The identified offset value, such as X from FIG. 3B, may then directly or indirectly indicate the number of slots between the PDCCH transmission and the CSI-RS transmission. When the identified offset value indirectly indicates the number of slots, the UE 115 may use the identified offset value to determine the number of slots based on using the identified value in a formula or in a lookup table.

At 530, the base station 105 generates and transmits the particular CSI-RS transmission. For example, the base station 105 may determine the offset for the CSI-RS transmission similar to the UE 115, and the base station 105 transmits the CSI-RS transmission based on the determined offset.

At 535, the UE 115 performs channel estimation based on the CSI-RS transmission. For example, the UE 115 determines one or more metric/parameter values based on the CSI-RS transmission and for inclusion in a CSI report. As another example, the UE 115 may select a particular reference signal of the CSI-RS transmission based on performance and/or conditions for inclusion in a CSI report.

At 540, the UE 115 generates and transmits a CSI report based on the CSI-RS transmission. For example, the UE 115 generates a CSI report message including the CSI report and transmits the CSI report message to the base station 105. The CSI report message may include or correspond to a conventional type CSI report message. The CSI report itself may be generated based on a selected reference signal or signals and/or the channel estimation. The CSI report may include or more of transmission parameters, reception parameters, and/or performance metrics. The CSI report format may be set by the base station 105 in the RRC message, another RRC message, the PDCCH transmission, or another PDCCH transmission.

The offset of the CSI report transmission from the PDCCH transmission may be determined by the UE 115 similar to how the UE 115 determines the offset for the CSI-RS transmission, such as described with reference to FIG. 4. Alternatively, the offset of the CSI report transmission from the PDCCH transmission may be determined by the UE 115 based on conventional methods, such as described with reference to FIG. 3B.

After the base station 105 receives the CSI report at 540, the base station 105 and the UE 115 may exchange data. For example, the base station 105 may transmit downlink data to the UE 115 at 545, and the UE 115 may transmit uplink data to the base station 105 at 550. Responsive to receiving the downlink data, the UE 115 may transmit an acknowledgment message at 555. For example, the UE 115 may transmit and ACK based on successfully receiving and decoding of the downlink data or a NACK based on unsuccessfully receiving or decoding the downlink data.

Thus, in the example in FIG. 5, the UE performs conditional usage of a received set of CSI-RS offset value for aperiodic triggering. That is, the UE evaluates whether or not to use the received set of CSI-RS offset values based on UE settings and/or operating modes.

Referring to FIG. 6, FIG. 6 is a ladder diagram of an example CSI-RS triggering operation. In the example of FIG. 6, the ladder diagram illustrates a UE and a network entity, such as base station 105. As compared to the conditional use of a received set of CSI-RS offset values in the ladder diagram of FIG. 5, the ladder diagram of FIG. 6 illustrates the usage of a fixed CSI-RS offset value. The fixed CSI-RS offset value may be set by the network and transmitted in a higher layer configuration message (e.g., RRC message configuring aperiodic CSI-RS transmissions) or in a lower layer trigger message (e.g., a PDCCH transmission triggering a particular aperiodic CSI-RS transmission). In the example of FIG. 6, the fixed CSI-RS offset value is indicated in a higher layer configuration message.

At 610, the base station 105 (e.g., gNB) determines to use and set a fixed CSI-RS offset value. For example, the base station 105 determines to use a fixed CSI-RS offset value for a particular UE, such as UE 115, based on the UE 115 being configured with one or more minimum scheduling conditions for cross-slot scheduling, such as a minimumSchedulingOffsetK0 IE, a minimumSchedulingOffsetK2 IE, or both. The base station 105 may know that the UE 115 is configured with such conditions because the base station 105 may have configured the UE 115 with such conditions by transmission of a previous RRC message (not shown) or a previous PDCCH transmission (not shown). If the UE is not configured with a minimumSchedulingOffsetK0 for any DL BWP or a minimumSchedulingOffsetK2 for any UL BWP, and if all the associated trigger states do not have a higher layer parameter of qcl-Type set to ‘QCL-TypeD’ in the corresponding TCI states, the RRC configured value of the CSI-RS triggering offset is fixed to zero.

In some implementations, the base station 105 determines to set the fixed CSI-RS offset value for aperiodic CSI-RS offset determination by: determining whether the UE 115 is configured with a minimumSchedulingOffsetK0 IE for any downlink Bandwidth Part (BWP) or with a minimumSchedulingOffsetK2 IE for any uplink BWP; and determining to set the fixed CSI-RS offset value based on determining that the UE 115 is not configured with a minimumSchedulingOffsetK0 IE for any downlink BWP or not configured with a minimumSchedulingOffsetK2 IE for any uplink BWP.

Additionally, or alternatively, the base station 105 determines to not use or set the fixed CSI-RS offset value based on determining that the UE is configured with a minimumSchedulingOffsetK0 IE for any downlink BWP and with a minimumSchedulingOffsetK2 IE for any uplink BWP. In a particular implementation, the base station 105 determines to use a set of CSI-RS values, such as a standard set or extended set, based on determining that the UE is configured with a minimumSchedulingOffsetK0 IE for any downlink BWP and with a minimumSchedulingOffsetK2 IE for any uplink BWP.

Additionally, or alternatively, the base station 105 determines to set the fixed CSI-RS offset value for aperiodic CSI-RS offset determination based on QCL Type. For example, the base station 105 determines whether the UE is configured with a higher layer parameter of qcl-Type set to QCL-TypeD in corresponding TCI states, and determines to set the fixed CSI-RS offset value based on determining that the UE is not configured with the higher layer parameter of qcl-Type set to QCL-TypeD in corresponding TCI states. In addition, the base station 105 may determine to not set or use the fixed CSI-RS offset value based on determining that the UE is configured with the higher layer parameter of qcl-Type set to QCL-TypeD in corresponding TCI states. In a particular implementation, the base station 105 determines to use a set of CSI-RS values, such as a standard set or an extended, set based on determining that the UE is configured with a minimumSchedulingOffsetK0 IE for any downlink BWP and with the higher layer parameter of qcl-Type set to QCL-TypeD in corresponding TCI states.

At 615, the base station 105 generates and transmits an RRC message. For example, the base station 105 sends an RRC configuration message for CSI-RS, such as a aperiodic CSI-RS configuration message, to the UE 115. The RRC message includes or indicates a fixed CSI-RS offset value for aperiodic trigger time determination. As described above, the RRC message may indicate or an include an IE that includes a single offset value, i.e., a fixed offset value, or includes an indicator configured to use a fixed offset value for aperiodic CSI-RS triggering. Alternatively, in implementations where a lower layer trigger message includes the fixed offset value, the RRC message may indicate or include an IE that includes a set of CSI-RS offset values, as described with reference to FIG. 5.

At 620, the UE 115 determines the fixed offset value from the RRC message. For example, the UE 115 parses the RRC message to determine the IE or indicator and sets the fixed offset value indicated by the IE or indicator for aperiodic CSI-RS triggering. In such implementations, the UE 115 may not use conditions to evaluate whether to use the fixed offset value or not. Rather, the base station 105 may determine that a fixed offset, such as an offset value of zero, may be applicable based on the UE or network capabilities or conditions. To illustrate, the network may determine if the UE is from an older generation or has cross-slot scheduling capabilities, and responsive to determining either or both conditions exits, the network may determine to use fixed offsets.

At 625, the base station 105 (e.g., gNB) generates and transmits a PDCCH transmission. For example, the base station 105 sends a DCI or a MAC CE to trigger a particular CSI-RS transmission, i.e., an aperiodic CSI-RS transmission. The PDCCH transmission may include or indicate an indicator for a set of CSI-RS offset values. In such implementations, the UE 115 may ignore the indicator and use the previously set fixed offset from the RRC message. Alternatively, the PDCCH transmission may not include an indicator when the RRC message specifies the fixed offset value.

In other implementations where the higher layer message does not include the fixed offset value, the PDCCH transmission may indicate the fixed offset value. In such implementations, the PDCCH transmission includes an indicator is configured to identify an entry of a received set of CSI-RS offset values, and an indicator to use a fixed offset that was previously set of configured by the network. When the PDCCH transmission includes an indicator configured to identify an entry of the received set of CSI-RS offset values, every PDCCH trigger transmissions sent by the network over a period of time may include the same indicator which identifies that the same value, i.e., the fixed offset value.

At 630, the UE 115 determines a particular CSI-RS offset for the aperiodic CSI-RS transmission. For example, the UE 115 determines a particular offset, such as a number of slots, between the PDCCH transmission and the CSI-RS transmission based on the fixed CSI-RS offset value, which may be indicated by the RRC message, as in the example of FIG. 6, or which may be indicated by the PDCCH transmission in other implementations. The identified fixed CSI-RS offset value may then directly or indirectly indicate the number of slots between the PDCCH transmission and the CSI-RS transmission. When the identified fixed CSI-RS offset value indirectly indicates the number of slots, the UE 115 may use the identified fixed CSI-RS offset value to determine the number of slots based on using the identified fixed CSI-RS value in a formula or in a lookup table.

At 635, the base station 105 generates and transmits the particular CSI-RS transmission. For example, the base station 105 may determine the offset for the CSI-RS transmission similar to the UE 115, and the base station 105 transmits the CSI-RS transmission based on the determined offset.

At 640, the UE 115 performs channel estimation based on the CSI-RS transmission. For example, the UE 115 determines one or more metric/parameter values based on the CSI-RS transmission and for inclusion in a CSI report. As another example, the UE 115 may select a particular reference signal of the CSI-RS transmission based on performance and/or conditions for inclusion in a CSI report.

At 645, the UE 115 generates and transmits a CSI report based on the CSI-RS transmission. For example, the UE 115 generates a CSI report message including the CSI report and transmits the CSI report message to the base station 105. The CSI report message may include or correspond to a conventional type CSI report message. The CSI report itself may be generated based on a selected reference signal or signals and/or the channel estimation. The CSI report may include or more of transmission parameters, reception parameters, and/or performance metrics. The CSI report format may be set by the base station 105 in the RRC message, another RRC message, the PDCCH transmission, or another PDCCH transmission.

The offset of the CSI report transmission from the PDCCH transmission may be determined by the UE 115 similar to how the UE 115 determines the offset for the CSI-RS transmission based on a fixed offset value, similar to as described with reference to FIG. 6, or based on conditionally using a set of received offset values, such as described with reference to FIGS. 4 and 5. Alternatively, the offset of the CSI report transmission from the PDCCH transmission may be determined by the UE 115 based on conventional methods, such as described with reference to FIG. 3B.

After the base station 105 receives the CSI report at 640, the base station 105 and the UE 115 may exchange data. For example, the base station 105 may transmit downlink data to the UE 115 at 645. Additionally or alternatively, the UE 115 may transmit uplink data to the base station 105, such as described with reference to FIG. 5. Responsive to receiving the downlink data, the UE 115 may transmit an acknowledgment message, such as described with reference to FIG. 5. For example, the UE 115 may transmit and ACK based on successfully receiving and decoding of the downlink data or a NACK based on unsuccessfully receiving or decoding the downlink data.

Thus, in the example in FIG. 5, the UE performs conditional usage of a received set of CSI-RS offset value for aperiodic triggering. That is, the UE evaluates whether or not to use the received set of CSI-RS offset values based on UE settings and/or operating modes

Thus, in the example in FIG. 6, the network conditional usage of a fixed CSI-RS offset value for aperiodic triggering. That is, the network additionally evaluates whether to use a regular set of CSI-RS offset values, an extended set of CSI-RS offset values, or a fixed CSI-RS offset based on one or more minimum scheduling conditions (e.g., restrictions) for cross-slot scheduling. That way, when the network configures the UE for aperiodic triggering, the network may prevent interoperability issues with minimum scheduling conditions for cross-slot scheduling. Accordingly, the network can enable the UE to use such minimum scheduling conditions for cross-slot scheduling which may result in power savings.

Additionally, or alternatively, one or more operations of FIGS. 3B, and 4-6 may be added, removed, substituted in other implementations. For example, in some implementations, a UE may determine a CSI-RS offset based on conditionally using a received set of offset values as in FIG. 5 and may identify a CSI report offset conventionally as in FIG. 3B or based on a fixed value as in FIG. 6.

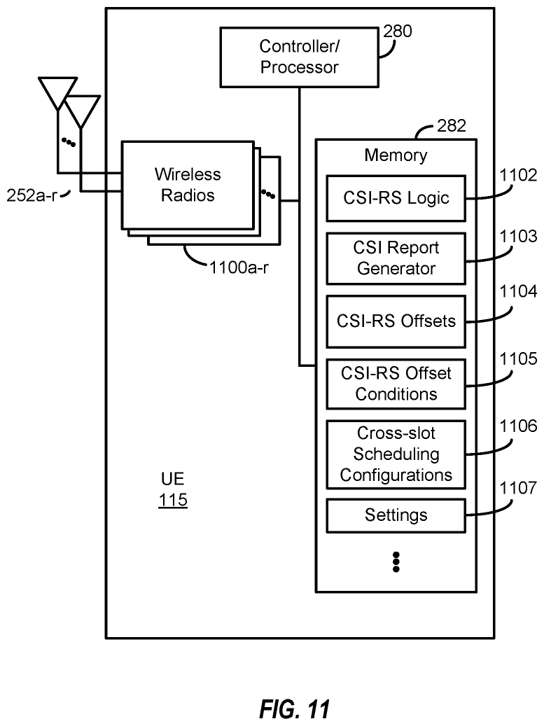

FIG. 7 is a flow diagram illustrating example blocks executed by a UE configured according to an aspect of the present disclosure. The example blocks will also be described with respect to UE 115 as illustrated in FIG. 11. FIG. 11 is a block diagram illustrating UE 115 configured according to one aspect of the present disclosure. UE 115 includes the structure, hardware, and components as illustrated for UE 115 of FIG. 2. For example, UE 115 includes controller/processor 280, which operates to execute logic or computer instructions stored in memory 282, as well as controlling the components of UE 115 that provide the features and functionality of UE 115. UE 115, under control of controller/processor 280, transmits and receives signals via wireless radios 1100a-r and antennas 252a-r. Wireless radios 1100a-r includes various components and hardware, as illustrated in FIG. 2 for UE 115, including modulator/demodulators 254a-r, MIMO detector 256, receive processor 258, transmit processor 264, and TX MIMO processor 266. As illustrated in the example of FIG. 11, memory 282 stores CSI-RS logic 1102, CSI Report Generator 1103, CSI-RS offsets data 1104, CSI-RS offset conditions data 1105, cross-slot scheduling configurations data 1106, and settings data 1107.

At block 700, a wireless communication device, such as a UE, receives a control message indicating a reference signal offset information element (IE) for aperiodic reference signal offset determination. For example, the UE 115 receives a RRC message or another control message indicating reference signal offset IE for aperiodic reference signal offset determination. In a particular implementation, the UE 115 receives a RRC message with an IE including a set of CSI-RS offset values, as described with reference to FIGS. 3B-6.

At block 701, the UE 115 receives a control channel transmission indicating a particular aperiodic reference signal transmission. For example, the UE 115 receives a control channel transmission (e.g., a PDCCH transmission) indicating a particular aperiodic transmission (e.g., a CSI-RS transmission). In a particular implementation, the UE 115 receives a DCI and/or a MAC CE which triggers a CSI-RS transmission, as described with reference to FIGS. 4-6.

At block 702, the UE 115 receives the particular aperiodic reference signal transmission based on a particular reference signal offset. The particular reference signal offset is determined based on the control channel transmission and a set of reference signal offset values. The set of reference signal offset values determined based on the reference signal offset IE and based on one or more minimum scheduling conditions for cross-slot scheduling. To illustrate, the UE 115 determines a set of reference signal offset values to use based on the reference signal offset IE and based on one or more minimum scheduling conditions for cross-slot scheduling. The UE 115 determines a particular reference signal offset for the particular aperiodic reference signal transmission based on the control transmission and the set of reference signal offset values. The UE 115 then monitors for the particular reference signal transmission during the determined offset time, such as a number of slots from the control transmission, and receives the particular reference signal transmission, as described with reference to FIGS. 4-6.

In some implementations, the UE 115 determines a set of CSI-RS offset values to use based on the CSI-RS offset IE and based on one or more minimum scheduling conditions for cross-slot scheduling. For example, the UE 115 determines whether to use the received set of CSI-RS offset values based on one or more cross-slot scheduling configurations for power saving, as described with reference to FIGS. 4-6. Additionally or alternatively, the UE 115 determines a particular CSI-RS offset for the particular aperiodic CSI-RS transmission based on the PDCCH transmission and the set of CSI-RS offset values. For example, the UE 115 determines a particular CSI-RS offset value based on an indicator of the DCI and/or the MAC CE and uses the indicator to identify an entry of the set of CSI-RS offset values, as described with reference to FIGS. 4-6.

The UE 115 may execute additional blocks (or the UE 115 may be configured further perform additional operations) in other implementations. For example, the UE 115 may perform one or more operations described above. As another example, the UE 115 may perform one or more aspects as described below.

In a first aspect, the particular reference signal offset indicates a timing from the control channel transmission to the particular aperiodic reference signal transmission.

In a second aspect, alone or in combination with one or more of the above aspects, the reference signal offset IE comprises a aperiodicTriggeringOffset IE, and the aperiodicTriggeringOffset IE comprises an extended set of offset values.

In a third aspect, alone or in combination with one or more of the above aspects, the extended set of offset values includes more than 7 values.

In a fourth aspect, alone or in combination with one or more of the above aspects, the control channel transmission and the particular aperiodic reference signal transmission have a same numerology.

In a fifth aspect, alone or in combination with one or more of the above aspects, the control channel transmission and the aperiodic reference signal transmission have a same sub-carrier spacing, a same cyclic prefix type, or both.

In a sixth aspect, alone or in combination with one or more of the above aspects, the control channel transmission and the aperiodic reference signal transmission have a different numerology.

In a seventh aspect, alone or in combination with one or more of the above aspects, the control channel transmission and the aperiodic reference signal transmission have different sub-carrier spacing.

In an eighth aspect, alone or in combination with one or more of the above aspects, a first sub-carrier spacing of the control channel transmission is greater than a second sub-carrier spacing of the aperiodic reference signal transmission.

In a ninth aspect, alone or in combination with one or more of the above aspects, the UE 115 further communicates data based on the particular aperiodic reference signal transmission.

In a tenth aspect, alone or in combination with one or more of the above aspects, communicating the data includes: transmit uplink data based on the particular aperiodic reference signal transmission; receive downlink data based on the particular aperiodic reference signal transmission; or transmit or receive sidelink data based on the particular aperiodic reference signal transmission.

In an eleventh aspect, alone or in combination with one or more of the above aspects, the reference signal offset information element (IE) comprises a Channel State Information (CSI) Reference Signal (CSI-RS) IE, and the particular aperiodic reference signal transmission comprises a particular aperiodic CSI-RS transmission.

In a twelfth aspect, alone or in combination with one or more of the above aspects, the control channel transmission is a Physical Downlink Control Channel (PDCCH) transmission.

In a thirteenth aspect, alone or in combination with one or more of the above aspects, the UE 115 further sets the set of CSI-RS offset values to use based on the CSI-RS offset IE and based on the one or more minimum scheduling conditions for cross-slot scheduling; and determines the particular CSI-RS offset for the particular aperiodic CSI-RS transmission based on the PDCCH transmission and the set of CSI-RS offset values. Alternatively, the UE 115 may determine or select the set of CSI-RS offset values to use based on the CSI-RS offset IE and based on the one or more minimum scheduling conditions for cross-slot scheduling.

In a fourteenth aspect, alone or in combination with one or more of the above aspects, the UE 115 further: performs channel measurements on the particular aperiodic CSI-RS transmission; generates a CSI Report based on the channel measurements; and transmits the CSI Report based on the particular aperiodic CSI-RS transmission.

In a fifteenth aspect, alone or in combination with one or more of the above aspects, determining the set of CSI-RS offset values to use includes: to determine whether the UE is configured with a minimumSchedulingOffsetK0 IE for any downlink Bandwidth Part (BWP); and to determine to use the received CSI-RS offset IE based on determining that the UE is configured with a minimumSchedulingOffsetK0 IE for any downlink BWP. Additionally, or alternatively, determining the set of CSI-RS offset values to use includes: the UE 115 determining to use an alternative CSI-RS offset IE based on determining that the UE is not configured with a minimumSchedulingOffsetK0 IE for any downlink BWP.

In a sixteenth aspect, alone or in combination with one or more of the above aspects, determining the set of CSI-RS offset values to use includes: to determine whether the UE is configured with a minimumSchedulingOffsetK0 IE for any downlink Bandwidth Part (BWP) or a minimumSchedulingOffsetK2 IE for any uplink BWP; and determine to use the received CSI-RS offset IE based on determining that the UE is configured with a minimumSchedulingOffsetK0 IE for any downlink BWP or with a minimumSchedulingOffsetK2 IE for any uplink BWP. Additionally, or alternatively, determining the set of CSI-RS offset values to use includes: the UE 115 determining to use an alternative CSI-RS offset IE based on determining that the UE is not configured with a minimumSchedulingOffsetK0 IE for any downlink BWP and not configured with a minimumSchedulingOffsetK2 IE for any uplink BWP.

In a seventeenth aspect, alone or in combination with one or more of the above aspects, determining the set of CSI-RS offset values to use includes: to determine whether the UE is configured with a minimumSchedulingOffsetK0 IE for any downlink Bandwidth Part (BWP) and with a minimumSchedulingOffsetK2 IE for any uplink BWP; and to determine to use the received CSI-RS offset IE based on determining that the UE is configured with a minimumSchedulingOffsetK0 IE for any downlink BWP and with a minimumSchedulingOffsetK2 IE for any uplink BWP. Additionally, or alternatively, determining the set of CSI-RS offset values to use includes: the UE 115 determining to use an alternative CSI-RS offset IE based on determining that the UE is not configured with a minimumSchedulingOffsetK0 IE for any downlink BWP or not configured with a minimumSchedulingOffsetK2 IE for any uplink BWP.

In an eighteenth aspect, alone or in combination with one or more of the above aspects, the CSI-RS offset IE comprises an aperiodicTriggeringOffsetExt-r16 IE which includes more than 7 values.

In a nineteenth aspect, alone or in combination with one or more of the above aspects, the aperiodicTriggeringOffsetExt-r16 IE includes 32 values from {0, 1, 2, 3, . . . 31}.

In a twentieth aspect, alone or in combination with one or more of the above aspects, determining the set of CSI-RS offset values to use based on the CSI-RS offset IE includes: determine whether the UE is configured with a minimumSchedulingOffsetK0 IE for any downlink Bandwidth Part (BWP); and determine to use the received CSI-RS offset IE based on determining that the UE is configured with a minimumSchedulingOffsetK0 IE for any downlink BWP.

In a twenty-first aspect, alone or in combination with one or more of the above aspects, determining the set of CSI-RS offset values to use based on the CSI-RS offset IE includes: to determine whether the UE is configured with a minimumSchedulingOffsetK0 IE for any downlink Bandwidth Part (BWP) or with a minimumSchedulingOffsetK2 IE for any uplink BWP; and to determine to use the received CSI-RS offset IE based on determining that the UE is configured with a minimumSchedulingOffsetK0 IE for any downlink BWP or with a minimumSchedulingOffsetK2 IE for any uplink BWP.

In a twenty-second aspect, alone or in combination with one or more of the above aspects, determining the set of CSI-RS offset values to use based on the CSI-RS offset IE includes: to determine whether the UE is configured with a minimumSchedulingOffsetK0 IE for any downlink Bandwidth Part (BWP) and with a minimumSchedulingOffsetK2 IE for any uplink BWP; and to determine to use the received CSI-RS offset IE based on determining that the UE is configured with a minimumSchedulingOffsetK0 IE for any downlink BWP and with a minimumSchedulingOffsetK2 IE for any uplink BWP.

In a twenty-third aspect, alone or in combination with one or more of the above aspects, the UE 115 further: receives a second RRC message indicating a fixed CSI-RS offset for aperiodic CSI-RS offset determination; receives a second PDCCH transmission indicating a second particular aperiodic CSI-RS transmission; receives the second particular aperiodic CSI-RS transmission based on a second particular CSI-RS offset, the second particular CSI-RS offset determined based on the PDCCH transmission and the fixed CSI-RS offset.

In a twenty-fourth aspect, alone or in combination with one or more of the above aspects, the UE 115 further, prior to receiving the control channel transmission, receives the one or more minimum scheduling conditions for cross-slot scheduling.

In a twenty-fifth aspect, alone or in combination with one or more of the above aspects, determining the particular reference signal offset for the particular aperiodic reference signal transmission includes: to select the particular reference signal offset from the set of reference signal offset values based on an offset indicator value of the control channel transmission.

In a twenty-sixth aspect, alone or in combination with one or more of the above aspects, the set of reference signal offset values includes an extended set of CSI-RS offset values.

In a twenty-seventh aspect, alone or in combination with one or more of the above aspects, the extended set of CSI-RS offset values includes more than 7 values.

In a twenty-eighth aspect, alone or in combination with one or more of the above aspects, the extended set of CSI-RS offset values includes {0, 1, 2, 3, 4, 5, 6, . . . , 15, 16, 24}.

In a twenty-ninth aspect, alone or in combination with one or more of the above aspects, the control channel transmission comprises a downlink control information (DCI) message or a Medium Access Control (MAC) Control Element (MAC CE).

Accordingly, a UE and a base station may perform enhanced reference signal triggering operations. By performing enhanced reference signal triggering operations, throughput and reliability may be increased.

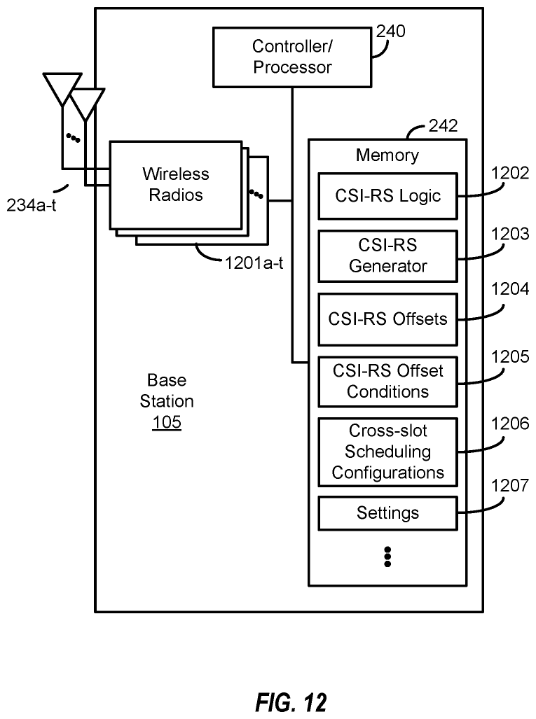

FIG. 8 is a flow diagram illustrating example blocks executed by wireless communication device configured according to another aspect of the present disclosure. The example blocks will also be described with respect to base station 105 (e.g., gNB) as illustrated in FIG. 12. FIG. 12 is a block diagram illustrating base station 105 configured according to one aspect of the present disclosure. Base station 105 includes the structure, hardware, and components as illustrated for base station 105 of FIG. 2. For example, base station 105 includes controller/processor 240, which operates to execute logic or computer instructions stored in memory 242, as well as controlling the components of base station 105 that provide the features and functionality of base station 105. Base station 105, under control of controller/processor 240, transmits and receives signals via wireless radios 1201a-t and antennas 234a-t. Wireless radios 1201a-t includes various components and hardware, as illustrated in FIG. 2 for base station 105, including modulator/demodulators 232a-t, MIMO detector 236, receive processor 238, transmit processor 220, and TX MIMO processor 230. As illustrated in the example of FIG. 14, memory 242 stores CSI-RS logic 1202, CSI-RS generator 1203, CSI-RS offsets data 1204, CSI-RS offset conditions data 1205, cross-slot scheduling configurations data 1206, and settings data 1207. One of more of 1202-1207 may include or correspond to one of 1102-1107.

At block 800, a wireless communication device, such as a base station, transmits a control message indicating a reference signal offset information element (IE) for aperiodic reference signal offset determination. For example, the base station 105 transmits a RRC message or another control message indicating reference signal offset IE for aperiodic reference signal offset determination. In a particular implementation, the base station 105 transmits a RRC messages with an IE including a set of CSI-RS offset values, as described with reference to FIGS. 3B-6.

At block 801, the base station 105 a control channel transmission indicating a particular aperiodic reference signal transmission. For example, the base station 105 transmits a control channel transmission (e.g., a PDCCH transmission) indicating a particular aperiodic transmission (e.g., a CSI-RS transmission). In a particular implementation, the base station 105 transmits a DCI and/or a MAC CE which triggers a CSI-RS transmission, as described with reference to FIGS. 4-6.

At block 802, the base station 105 transmits the particular aperiodic reference signal transmission based on a particular reference signal offset. The particular reference signal offset is determined based on the control channel transmission and a set of reference signal offset values. The set of reference signal offset values determined based on the reference signal offset IE and based on one or more minimum scheduling conditions for cross-slot scheduling. To illustrate, the base station 105 determines a set of reference signal offset values to use based on the reference signal offset IE and based on one or more minimum scheduling conditions for cross-slot scheduling. The base station 105 determines a particular reference signal offset for the particular aperiodic reference signal transmission based on the control transmission and the set of reference signal offset values. The base station 105 then transmits the particular reference signal transmission during the determined offset time, such as a number of slots from the control transmission, as described with reference to FIGS. 4-6.

In some implementations, the base station 105 determines a set of CSI-RS offset values to use based on the CSI-RS offset IE and based on one or more minimum scheduling conditions for cross-slot scheduling. For example, the base station 105 determines whether to use the transmitted set of CSI-RS offset values based on one or more cross-slot scheduling configurations for power saving for the UE 115, as described with reference to FIGS. 4-6. To illustrate, as the base station 105 previously sent the cross-slot configurations to the UE 115, the base station 105 knows the cross-slot configurations of the UE 115.

Additionally or alternatively, the base station 105 determines a particular CSI-RS offset for the particular aperiodic CSI-RS based on the PDCCH transmission and the set of CSI-RS offset values. For example, the base station 105 determines a particular CSI-RS offset value based on an indicator of the DCI and/or a MAC CE and uses the indicator to identify an entry of the set of CSI-RS offset values, as described with reference to FIGS. 4-6.

The base station 105 may execute additional blocks (or the base station 105 may be configured further perform additional operations) in other implementations. For example, the base station 105 may perform one or more operations described above. As another example, the base station 105 may perform one or more aspects as described below.

In a first aspect, the particular reference signal offset indicates a timing from the control channel transmission to the particular aperiodic reference signal transmission.

In a second aspect, alone or in combination with one or more of the above aspects, the reference signal offset IE comprises a aperiodicTriggeringOffset IE, and the aperiodicTriggeringOffset IE comprises an extended set of offset values.

In a third aspect, alone or in combination with one or more of the above aspects, the extended set of offset values includes more than 7 values.

In a fourth aspect, alone or in combination with one or more of the above aspects, the control channel transmission and the particular aperiodic reference signal transmission have a same numerology.

In a fifth aspect, alone or in combination with one or more of the above aspects, the control channel transmission and the aperiodic reference signal transmission have a same sub-carrier spacing, a same cyclic prefix type, or both.

In a sixth aspect, alone or in combination with one or more of the above aspects, the control channel transmission and the aperiodic reference signal transmission have a different numerology.

In a seventh aspect, alone or in combination with one or more of the above aspects, the control channel transmission and the aperiodic reference signal transmission have different sub-carrier spacing.

In an eighth aspect, alone or in combination with one or more of the above aspects, a first sub-carrier spacing of the control channel transmission is greater than a second sub-carrier spacing of the aperiodic reference signal transmission.

In a ninth aspect, alone or in combination with one or more of the above aspects, the base station 105 further communicates data based on the particular aperiodic reference signal transmission.

In a tenth aspect, alone or in combination with one or more of the above aspects, communicating the data includes: transmit uplink data based on the particular aperiodic reference signal transmission; receive downlink data based on the particular aperiodic reference signal transmission; or transmit or receive sidelink data based on the particular aperiodic reference signal transmission.

In an eleventh aspect, alone or in combination with one or more of the above aspects, the reference signal offset information element (IE) comprises a Channel State Information (CSI) Reference Signal (CSI-RS) IE, and the particular aperiodic reference signal transmission comprises a particular aperiodic CSI-RS transmission.

In a twelfth aspect, alone or in combination with one or more of the above aspects, the control channel transmission is a Physical Downlink Control Channel (PDCCH) transmission.

In a thirteenth aspect, alone or in combination with one or more of the above aspects, the base station 105 further sets the set of CSI-RS offset values to use based on the CSI-RS offset IE and based on the one or more minimum scheduling conditions for cross-slot scheduling; and determines the particular CSI-RS offset for the particular aperiodic CSI-RS transmission based on the PDCCH transmission and the set of CSI-RS offset values. Alternatively, the base station 105 may determine or select the set of CSI-RS offset values to use based on the CSI-RS offset IE and based on the one or more minimum scheduling conditions for cross-slot scheduling.

In a fourteenth aspect, alone or in combination with one or more of the above aspects, the base station 105 further receives a CSI Report based on the particular aperiodic CSI-RS transmission.

In a fifteenth aspect, alone or in combination with one or more of the above aspects, determining the set of CSI-RS offset values to use includes: to determine whether the UE is configured with a minimumSchedulingOffsetK0 IE for any downlink Bandwidth Part (BWP); and to determine to use the received CSI-RS offset IE based on determining that the UE is configured with a minimumSchedulingOffsetK0 IE for any downlink BWP. Additionally, or alternatively, determining the set of CSI-RS offset values to use includes: the base station 105 determining to use an alternative CSI-RS offset IE is based on determining that the UE is not configured with a minimumSchedulingOffsetK0 IE for any downlink BWP.

In a sixteenth aspect, alone or in combination with one or more of the above aspects, determining the set of CSI-RS offset values to use includes: to determine whether the UE is configured with a minimumSchedulingOffsetK0 IE for any downlink Bandwidth Part (BWP) or a minimumSchedulingOffsetK2 IE for any uplink BWP; and determine to use the received CSI-RS offset IE based on determining that the UE is configured with a minimumSchedulingOffsetK0 IE for any downlink BWP or with a minimumSchedulingOffsetK2 IE for any uplink BWP. Additionally, or alternatively, determining the set of CSI-RS offset values to use includes: the base station 105 determining to use an alternative CSI-RS offset IE based on determining that the UE is not configured with a minimumSchedulingOffsetK0 IE for any downlink BWP and not configured with a minimumSchedulingOffsetK2 IE for any uplink BWP.

In a seventeenth aspect, alone or in combination with one or more of the above aspects, determining the set of CSI-RS offset values to use includes: to determine whether the UE is configured with a minimumSchedulingOffsetK0 IE for any downlink Bandwidth Part (BWP) and with a minimumSchedulingOffsetK2 IE for any uplink BWP; and to determine to use the received CSI-RS offset IE based on determining that the UE is configured with a minimumSchedulingOffsetK0 IE for any downlink BWP and with a minimumSchedulingOffsetK2 IE for any uplink BWP. Additionally, or alternatively, determining the set of CSI-RS offset values to use includes: the base station 105 determining to use an alternative CSI-RS offset IE based on determining that the UE is not configured with a minimumSchedulingOffsetK0 IE for any downlink BWP or not configured with a minimumSchedulingOffsetK2 IE for any uplink BWP.

In an eighteenth aspect, alone or in combination with one or more of the above aspects, the CSI-RS offset IE comprises an aperiodicTriggeringOffsetExt-r16 IE which includes more than 7 values.

In a nineteenth aspect, alone or in combination with one or more of the above aspects, the aperiodicTriggeringOffsetExt-r16 IE includes 32 values from {0, 1, 2, 3, . . . 31}.

In a twentieth aspect, alone or in combination with one or more of the above aspects, determining the set of CSI-RS offset values to use based on the CSI-RS offset IE includes: determine whether the UE is configured with a minimumSchedulingOffsetK0 IE for any downlink Bandwidth Part (BWP); and determine to use the received CSI-RS offset IE based on determining that the UE is configured with a minimumSchedulingOffsetK0 IE for any downlink BWP.

In a twenty-first aspect, alone or in combination with one or more of the above aspects, determining the set of CSI-RS offset values to use based on the CSI-RS offset IE includes: to determine whether the UE is configured with a minimumSchedulingOffsetK0 IE for any downlink Bandwidth Part (BWP) or with a minimumSchedulingOffsetK2 IE for any uplink BWP; and to determine to use the received CSI-RS offset IE based on determining that the UE is configured with a minimumSchedulingOffsetK0 IE for any downlink BWP or with a minimumSchedulingOffsetK2 IE for any uplink BWP.

In a twenty-second aspect, alone or in combination with one or more of the above aspects, determining the set of CSI-RS offset values to use based on the CSI-RS offset IE includes: to determine whether the UE is configured with a minimumSchedulingOffsetK0 IE for any downlink Bandwidth Part (BWP) and with a minimumSchedulingOffsetK2 IE for any uplink BWP; and to determine to use the received CSI-RS offset IE based on determining that the UE is configured with a minimumSchedulingOffsetK0 IE for any downlink BWP and with a minimumSchedulingOffsetK2 IE for any uplink BWP.

In a twenty-third aspect, alone or in combination with one or more of the above aspects, the base station 105 further: transmits a second RRC message indicating a fixed CSI-RS offset for aperiodic CSI-RS offset determination; transmits a second PDCCH transmission indicating a second particular aperiodic CSI-RS transmission; transmits the second particular aperiodic CSI-RS transmission based on a second particular CSI-RS offset, the second particular CSI-RS offset determined based on the PDCCH transmission and the fixed CSI-RS offset.

In a twenty-fourth aspect, alone or in combination with one or more of the above aspects, the base station 105 further, prior to transmitting the control channel transmission, transmits the one or more minimum scheduling conditions for cross-slot scheduling.

In a twenty-fifth aspect, alone or in combination with one or more of the above aspects, determining the particular reference signal offset for the particular aperiodic reference signal transmission includes: to select the particular reference signal offset from the set of reference signal offset values based on an offset indicator value of the control channel transmission.

In a twenty-sixth aspect, alone or in combination with one or more of the above aspects, the set of reference signal offset values includes an extended set of CSI-RS offset values.

In a twenty-seventh aspect, alone or in combination with one or more of the above aspects, the extended set of CSI-RS offset values includes more than 7 values.

In a twenty-eighth aspect, alone or in combination with one or more of the above aspects, the extended set of CSI-RS offset values includes {0, 1, 2, 3, 4, 5, 6, . . . , 15, 16, 24}.

In a twenty-ninth aspect, alone or in combination with one or more of the above aspects, the control channel transmission comprises a downlink control information (DCI) message or a Medium Access Control (MAC) Control Element (MAC CE).

Accordingly, a UE and a base station may perform enhanced reference signal triggering operations. By performing enhanced reference signal triggering operations, throughput and reliability may be increased.

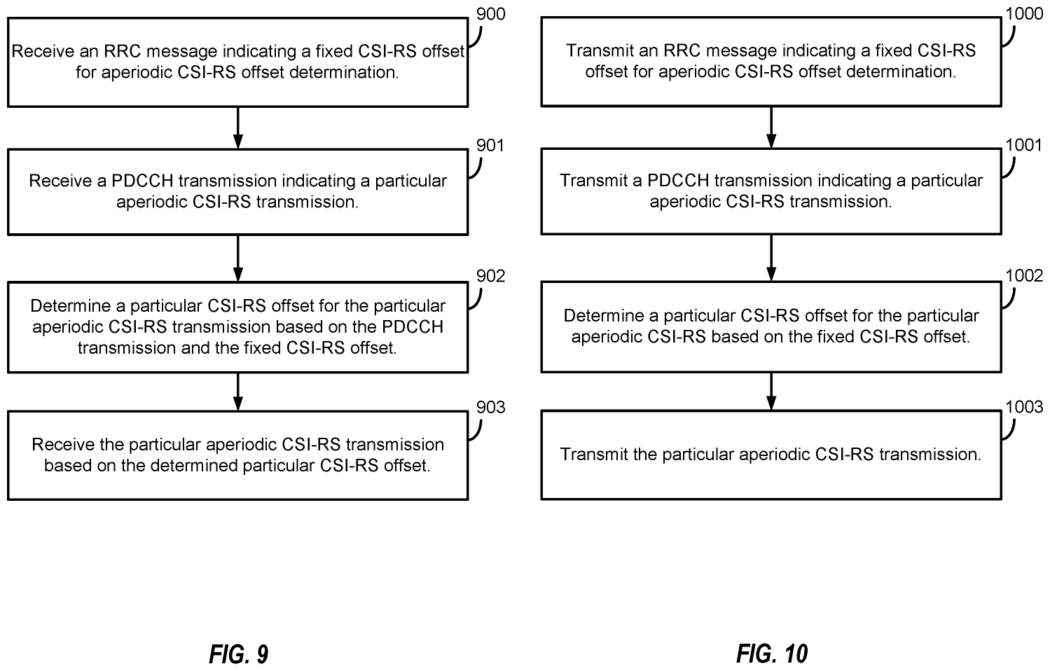

FIG. 9 is a flow diagram illustrating example blocks executed by a UE configured according to an aspect of the present disclosure. The example blocks will also be described with respect to UE 115 as illustrated in FIG. 11 and described above.

At block 900, a wireless communication device, such as a UE, receives an RRC message indicating a fixed CSI-RS offset for aperiodic CSI-RS offset determination. For example, the UE 115 receives a RRC message with a fixed CSI-RS offset for aperiodic CSI-RS offset determination, as described with reference to FIGS. 4-6. The fixed CSI-RS offset for aperiodic CSI-RS offset determination may be signaled by an indicator or included in an IE, as illustrative, non-limiting examples.

At block 901, the UE 115 receives a PDCCH transmission indicating a particular aperiodic CSI-RS transmission. For example, the UE 115 receives a DCI and/or a MAC CE which triggers a CSI-RS transmission, as described with reference to FIGS. 4-6.

At block 902, the UE 115 determines a particular CSI-RS offset for the particular aperiodic CSI-RS transmission based on the PDCCH transmission and the fixed CSI-RS offset. For example, the UE 115 determines a particular CSI-RS offset value based on fixed CSI-RS offset for aperiodic CSI-RS offset determination signaled by the RRC message, as described with reference to FIGS. 4-6. The CSI-RS offset may correspond to a number of slots indicated by the particular CSI-RS offset value from a slot of the PDCCH transmission. In some implementations, the particular CSI-RS offset value (e.g., number of slots) is determined further based on an indicator of the PDCCH transmission. In other implementations, the particular CSI-RS offset value (e.g., number of slots) is determined independent of the PDCCH transmission, as described with reference to FIGS. 4-6.

At block 903, the UE 115 receives the particular aperiodic CSI-RS transmission based on the determined particular CSI-RS offset. For example, the UE 115 monitors for the particular CSI-RS transmission during the determined offset time, such as a number of slots from the PDCCH transmission, and receives the particular CSI-RS transmission, as described with reference to FIGS. 4-6.

The UE 115 may execute additional blocks (or the UE 115 may be configured further perform additional operations) in other implementations. For example, the UE 115 may perform one or more operations described above. As another example, the UE 115 is: not configured with a minimumSchedulingOffsetK0 for any downlink Bandwidth Part (BWP) or not configured with a minimumSchedulingOffsetK2 for any uplink BWP; and does not have a higher layer parameter of qcl-Type set to QCL-TypeD in corresponding TCI states.

Accordingly, a UE and a base station may perform enhanced CSI-RS triggering operations. By performing enhanced CSI-RS triggering operations, throughput and reliability may be increased.

FIG. 10 is a flow diagram illustrating example blocks executed by a wireless communication device configured according to another aspect of the present disclosure. The example blocks will also be described with respect to base station 105 (e.g., gNB) as illustrated in FIG. 12 and described above.

At block 1000, a wireless communication device, such as a base station, transmits an RRC message indicating a fixed CSI-RS offset for aperiodic CSI-RS offset determination. For example, the base station 105 transmits a RRC messages with a fixed CSI-RS offset for aperiodic CSI-RS offset determination, as described with reference to FIGS. 4-6. The fixed CSI-RS offset for aperiodic CSI-RS offset determination may be signaled by an indicator or included in an IE, as illustrative, non-limiting examples.

At block 1001, the base station 105 transmits a PDCCH transmission indicating a particular aperiodic CSI-RS transmission. For example, the base station 105 transmits a DCI and/or a MAC CE which triggers a CSI-RS transmission, as described with reference to FIGS. 4-6.

At block 1002, the base station 105 determines a particular CSI-RS offset for the particular aperiodic CSI-RS based on the fixed CSI-RS offset. For example, the base station 105 determines a particular CSI-RS offset value based on fixed CSI-RS offset for aperiodic CSI-RS offset determination signaled by the RRC message, as described with reference to FIGS. 4-6. The CSI-RS offset may correspond to a number of slots indicated by the particular CSI-RS offset value from a slot of the PDCCH transmission. In some implementations, the particular CSI-RS offset value (e.g., number of slots) is determined further based on an indicator of the PDCCH transmission. In other implementations, the particular CSI-RS offset value (e.g., number of slots) is determined independent of the PDCCH transmission.

At block 1003, the base station 105 transmits the particular aperiodic CSI-RS transmission. For example, the base station 105 transmits the particular CSI-RS transmission during the determined offset time, such as a number of slots from the PDCCH transmission, as described with reference to FIGS. 4-6.

The base station 105 may execute additional blocks (or the base station 105 may be configured further perform additional operations) in other implementations. For example, the base station 105 may perform one or more operations described above. As another example, the base station 105 may perform one or more aspects as described below.

In a first aspect, prior to transmitting the RRC message, determining, by the network entity, to set the fixed CSI-RS offset for aperiodic CSI-RS offset determination.

In a second aspect, alone or in combination with one or more of the above aspects, determining to set the fixed CSI-RS offset value for aperiodic CSI-RS offset determination includes: the base station 105 determining whether the UE is configured with a minimumSchedulingOffsetK0 IE for any downlink Bandwidth Part (BWP) or with a minimumSchedulingOffsetK2 IE for any uplink BWP; and determining to set the fixed CSI-RS offset value based on determining that the UE is not configured with a minimumSchedulingOffsetK0 IE for any downlink BWP or not configured with a minimumSchedulingOffsetK2 IE for any uplink BWP. Additionally, or alternatively, determining to set the fixed CSI-RS offset value for aperiodic CSI-RS offset determination includes: the base station 105 determining to not use or set the fixed CSI-RS offset value based on determining that the UE is configured with a minimumSchedulingOffsetK0 IE for any downlink BWP and with a minimumSchedulingOffsetK2 IE for any uplink BWP. In a particular implementation, the base station 105 determines to use a set of CSI-RS values, such as a standard set or extended set, based on determining that the UE is configured with a minimumSchedulingOffsetK0 IE for any downlink BWP and with a minimumSchedulingOffsetK2 IE for any uplink BWP.

In a third aspect, alone or in combination with one or more of the above aspects, determining to set the fixed CSI-RS offset value for aperiodic CSI-RS offset determination further includes: the base station 105 determining whether the UE is configured with a higher layer parameter of qcl-Type set to QCL-TypeD in corresponding TCI states; and determining to set the fixed CSI-RS offset value based on determining that the UE is not configured with the higher layer parameter of qcl-Type set to QCL-TypeD in corresponding TCI states. Additionally, or alternatively, determining to set the fixed CSI-RS offset value for aperiodic CSI-RS offset determination includes: the base station 105 determining to not set or use the fixed CSI-RS offset value based on determining that the UE is configured with the higher layer parameter of qcl-Type set to QCL-TypeD in corresponding TCI states. In a particular implementation, the base station 105 determines to use a set of CSI-RS values, such as a standard set or an extended, set based on determining that the UE is configured with a minimumSchedulingOffsetKO IE for any downlink BWP and with the higher layer parameter of qcl-Type set to QCL-TypeD in corresponding TCI states.

Accordingly, a UE and a base station may perform enhanced CSI-RS triggering operations. By performing enhanced CSI-RS triggering operations, throughput and reliability may be increased.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and modules described herein (e.g., the components, functional blocks, and modules in FIG. 2) may comprise processors, electronics devices, hardware devices, electronics components, logical circuits, memories, software codes, firmware codes, etc., or any combination thereof. In addition, features discussed herein relating to enhanced CSI-RS aperiodic triggering operations may be implemented via specialized processor circuitry, via executable instructions, and/or combinations thereof.

Those of skill would further appreciate that the various illustrative logical blocks, modules, circuits, and algorithm steps (e.g., the logical blocks in FIGS. 7-10) described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), hard disk, solid state disk, and blu-ray disc where disks usually reproduce data magnetically, while discs reproduce data optically with lasers. Combinations of the above should also be included within the scope of computer-readable media.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C) or any of these in any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. An apparatus configured for wireless communication, comprising:
at least one processor; and
a memory coupled to the at least one processor,
wherein the at least one processor is configured to:
receive a control message indicating a reference signal offset information element (IE) for aperiodic reference signal offset determination;
receive a control channel transmission indicating a particular aperiodic reference signal transmission; and
receive the particular aperiodic reference signal transmission based on a particular reference signal offset, the particular reference signal offset determined based on the control channel transmission and a set of reference signal offset values, and the set of reference signal offset values determined based on the reference signal offset IE and based on one or more minimum scheduling conditions for cross-slot scheduling.

2. The apparatus of claim 1, wherein the particular reference signal offset indicates a timing from the control channel transmission to the particular aperiodic reference signal transmission.

3. The apparatus of claim 1, wherein the reference signal offset IE comprises a aperiodicTriggeringOffset IE, and wherein the aperiodicTriggeringOffset IE comprises an extended set of offset values.

4. The apparatus of claim 3, wherein the extended set of offset values includes more than 7 values.

5. The apparatus of claim 1, wherein the control channel transmission and the particular aperiodic reference signal transmission have a same numerology.

6. The apparatus of claim 5, wherein the control channel transmission and the aperiodic reference signal transmission have a same sub-carrier spacing, a same cyclic prefix type, or both.

7. The apparatus of claim 1, wherein the control channel transmission and the aperiodic reference signal transmission have a different numerology.

8. The apparatus of claim 7, wherein the control channel transmission and the aperiodic reference signal transmission have different sub-carrier spacing.

9. The apparatus of claim 8, wherein a first sub-carrier spacing of the control channel transmission is greater than a second sub-carrier spacing of the aperiodic reference signal transmission.

10. The apparatus of claim 1, further comprising:
communicate data based on the particular aperiodic reference signal transmission.

11. The apparatus of claim 10, wherein communicating the data includes:
transmit uplink data based on the particular aperiodic reference signal transmission;
receive downlink data based on the particular aperiodic reference signal transmission; or
transmit or receive sidelink data based on the particular aperiodic reference signal transmission.

12. The apparatus of claim 1, wherein the reference signal offset information element (IE) comprises a Channel State Information (CSI) Reference Signal (CSI-RS) IE, and wherein the particular aperiodic reference signal transmission comprises a particular aperiodic CSI-RS transmission.

13. The apparatus of claim 12, wherein the control channel transmission is a Physical Downlink Control Channel (PDCCH) transmission, wherein the set of reference signal offset values comprises a set of CSI-RS offset values, and wherein the particular reference signal offset comprises a particular CSI-RS offset.

14. The apparatus of claim 13, further comprising:
set the set of CSI-RS offset values to use based on the CSI-RS offset IE and based on the one or more minimum scheduling conditions for cross-slot scheduling; and
determine the particular CSI-RS offset for the particular aperiodic CSI-RS transmission based on the PDCCH transmission and the set of CSI-RS offset values.

15. The apparatus of claim 13, further comprising:
perform channel measurements on the particular aperiodic CSI-RS transmission;
generate a CSI Report based on the channel measurements; and
transmit the CSI Report based on the particular aperiodic CSI-RS transmission.

16. The apparatus of claim 13, wherein determining the set of CSI-RS offset values to use includes:
determine whether the apparatus is configured with a minimumSchedulingOffsetK0 IE for any downlink Bandwidth Part (BWP); and
determine to use the received CSI-RS offset IE based on determining that the apparatus is configured with a minimumSchedulingOffsetK0 IE for any downlink BWP.

17. The apparatus of claim 13, wherein determining the set of CSI-RS offset values to use includes:
determine whether the apparatus is configured with a minimumSchedulingOffsetK0 IE for any downlink Bandwidth Part (BWP) or a minimumSchedulingOffsetK2 IE for any uplink BWP; and
determine to use the received CSI-RS offset IE based on determining that the apparatus is configured with a minimumSchedulingOffsetK0 IE for any downlink BWP or with a minimumSchedulingOffsetK2 IE for any uplink BWP.

18. The apparatus of claim 13, wherein determining the set of CSI-RS offset values to use includes:
determine whether the apparatus is configured with a minimumSchedulingOffsetK0 IE for any downlink Bandwidth Part (BWP) and with a minimumSchedulingOffsetK2 IE for any uplink BWP; and
determine to use the received CSI-RS offset IE based on determining that the apparatus is configured with a minimumSchedulingOffsetK0 IE for any downlink BWP and with a minimumSchedulingOffsetK2 IE for any uplink BWP.

19. The apparatus of claim 13, wherein the CSI-RS offset IE comprises an aperiodicTriggeringOffsetExt-r16 IE which includes more than 7 values.

20. The apparatus of claim 19, wherein the aperiodicTriggeringOffsetExt-r16 IE includes 32 values from {0, 1, 2, 3, . . . 31}.

21. The apparatus of claim 13, wherein determining the set of CSI-RS offset values to use based on the CSI-RS offset IE includes:
determine whether the apparatus is configured with a minimumSchedulingOffsetK0 IE for any downlink Bandwidth Part (BWP); and
determine to use the received CSI-RS offset IE based on determining that the apparatus is configured with a minimumSchedulingOffsetK0 IE for any downlink BWP.

22. The apparatus of claim 13, wherein determining the set of CSI-RS offset values to use based on the CSI-RS offset IE includes:
determine whether the apparatus is configured with a minimumSchedulingOffsetK0 IE for any downlink Bandwidth Part (BWP) or with a minimumSchedulingOffsetK2 IE for any uplink BWP; and
determine to use the received CSI-RS offset IE based on determining that the apparatus is configured with a minimumSchedulingOffsetK0 IE for any downlink BWP or with a minimumSchedulingOffsetK2 IE for any uplink BWP.

23. The apparatus of claim 13, wherein determining the set of CSI-RS offset values to use based on the CSI-RS offset IE includes:
determine whether the apparatus is configured with a minimumSchedulingOffsetK0 IE for any downlink Bandwidth Part (BWP) and with a minimumSchedulingOffsetK2 IE for any uplink BWP; and
determine to use the received CSI-RS offset IE based on determining that the apparatus is configured with a minimumSchedulingOffsetK0 IE for any downlink BWP and with a minimumSchedulingOffsetK2 IE for any uplink BWP.

24. The apparatus of claim 13, further comprising:
receive a second RRC message indicating a fixed Channel State Information (CSI) Reference Signal (CSI-RS) offset for aperiodic CSI-RS offset determination;
receive a second PDCCH transmission indicating a second particular aperiodic CSI-RS transmission; and
receive the second particular aperiodic CSI-RS transmission based on a second particular CSI-RS offset, the second particular CSI-RS offset determined based on the PDCCH transmission and the fixed CSI-RS offset.

25. The apparatus of claim 1, further comprising, prior to receiving the control channel transmission:
receive the one or more minimum scheduling conditions for cross-slot scheduling.

26. The apparatus of claim 1, wherein determining the particular reference signal offset for the particular aperiodic reference signal transmission includes:
select the particular reference signal offset from the set of reference signal offset values based on an offset indicator value of the control channel transmission.

27. The apparatus of claim 1, wherein the set of reference signal offset values includes an extended set of Channel State Information (CSI) Reference Signal (CSI-RS) offset values.

28. The apparatus of claim 27, wherein the extended set of CSI-RS offset values includes more than 7 values.

29. The apparatus of claim 27, wherein the extended set of CSI-RS offset values includes {0, 1, 2, 3, 4, 5, 6, . . . , 15, 16, 24}.

30. The apparatus of claim 1, wherein the control channel transmission comprises a downlink control information (DCI) message or a Medium Access Control (MAC) Control Element (MAC CE).
